(19) United States
(12) Patent Application Publication
(10) Pub. No.: US 2018/0016392 A1
(43) Pub. Date: Jan. 18, 2018

(54) Modified alkoxylation products having at least one non-terminal alkoxy silyl group, with increased storage stability and improved elongation, and the polymers produced using said products

(71) Applicant: Evonik Degussa GmbH, Essen (DE)

(72) Inventors: Matthias Lobert, Essen (DE); Anke Lewin, Düsseldorf (DE); Wilfried Knott, Essen (DE); Frank Schubert, Neukirchen-Vluyn (DE); Michael Ferenz, Essen (DE); Heike Hahn, Bochum (DE); Dirk Wojtasik, Castrop-Rauxel (DE); Carina Eilitz, Mülheim an der Ruhr (DE)

(21) Appl. No.: 15/540,605

(22) PCT Filed: Jan. 5, 2016
(86) PCT No.: PCT/EP2016/050054

§ 371 Date: Jun. 29, 2017

(30) Foreign Application Priority Data
Jan. 28, 2015 (EP) 15152777.7

(51) Int. Cl. C08G 65/22; C08G 65/332; C08G 77/46; C08G 77/445

(52) U.S. Cl. CPC C08G 65/22; C08G 65/3322; C08G 77/46; C08G 77/445

(57) ABSTRACT

The present invention provides specific alkoxylation products, a process for preparing them, compositions comprising these alkoxylation products, and their use. In particular the present invention provides an alkoxylation product comprising at least one non-terminal alkoxysilyl group, formed from monomers of at least one alkylene oxide and at least one epoxide bearing alkoxysilyl groups, wherein at least 30% of all the free OH groups on the chain end of the alkoxylation product have been converted to acetoacetate groups.

The present invention relates to specific alkoxylation products, to a process for preparing them, to compositions comprising these alkoxylation products, and to their use, more particularly as adhesives and sealants containing alkoxysilyl groups.

In a multiplicity of operational procedures and manufacturing processes, an increasingly important role is being played by the use of adhesives and adhesive sealants, which additionally fulfil a sealing function. Relative to other joining processes, such as welding or riveting, for example, these processes offer advantages in terms of weight and costs, but also advantages in the transfer of stress between the components joined.

As compared with the joining of different materials, adhesive bonding has the advantage, moreover, that it is able to compensate the differences in deformation behaviour and in thermal expansion coefficients between the materials, especially when elastic adhesives are used, and hence actually allows such combinations of materials to be joined.

In the literature there are various examples of elastic adhesives. In recent years, in particular, adhesives based on what are called silane-modified polymers have found widespread application by virtue of their universal usefulness. Many examples in the literature address the formulation of adhesive, adhesive sealant and sealant systems for a multiplicity of applications. Mention may be made here, only by way of example, of specifications WO 2006/136211 A1, EP 1036807 B1 and WO 2010/004038 A1, which set out the fundamental concepts of the formulating technologies and formulating constituents that are customary in the art. The base polymer used is customarily a polyether which has been provided, in different processes, with moisture-crosslinking terminal alkoxysilane groups. This product group includes not only the silylated polyethers marketed by the company Kaneka under the name MS Polymer®, but also the so-called silylated polyurethanes (SPUR products, for example Desmoseal® S, Bayer Materials Science).

The use of polyether backbones in these products is an advantage primarily on account of their low glass transition temperature and the elastic deformation characteristics which are thereby ensured even at low temperatures. However, the silylated polyethers as described in specifications JP 09012863, JP 09012861 and JP 07062222, in particular, on account of their weak intermolecular interaction under service conditions, and the associated reduced intermolecular transmission of forces, do not possess the optimum profile for use in adhesives or sealants.

Silylated polyurethanes as described in DE 69831518 (WO 98/47939 A1) are clearly at an advantage here, since the urethane functions and the urea functions likewise present in specific products allow a high degree of intermolecular force transmission and hence high strengths on the part of the bonds. Silylated polyurethanes as well, however, are hampered by the problems associated with polyurethanes, such as the lack of temperature stability and yellowing stability, for example, and also the UV stability, which for certain applications is not sufficient.

Alkoxylation products can be prepared according to the prior art as per EP 2093244 (US 2010/0041910) by the reaction of a starter bearing (an) OH group(s) with propylene oxide and alkoxysilyl compound(s) containing one or more epoxy groups and, according to the embodiment, one or more comonomers by means of double metal cyanide catalysts (DMC catalysts). The document EP 2 093 244 and its disclosure, especially in relation to the structures described therein, is hereby incorporated in full into this description.

It is a feature of the alkoxylation products described therein for the first time that, in contrast to the prior art known until that date, the alkoxysilyl groups are distributed randomly or in blocks along the polyether chain, and are not just located at the termini of the chain. These compounds, furthermore, are notable for (a) terminal OH group(s), which is a consequence of the reaction. The presence of the OH group(s) and the hydrolysis-sensitive alkoxysilyl groups in one molecule is the basis for the intrinsic reactivity of the compounds and ready crosslinkability with formation of three-dimensional polymeric networks. Nevertheless, experiments have also shown that the reactivity of the OH group may be too high to achieve a shelf life sufficient for the requirements imposed on 1-component adhesive and sealant formulations. Shelf life in this context means the stability towards crosslinking or gelling of the completed, catalyst-containing formulation on storage in a standard commercial thick-walled cartridge.

The formulations produced therefrom have inadequate storage stability. Even at slightly elevated temperature (up to 60° C.), they crosslink within a few days in the presence of the metal and/or amine catalysts that are typically used in moisture-curing formulations.

Even though residual moisture in the formulation appears to promote crosslinking, it has been shown that, even under very dry conditions, incipient crosslinking of the formulation proceeds within a few days in a rapid storage test.

There has also been no lack of attempts to minimize the intrinsic reactivity of the terminal OH group(s) of said alkoxylation products by chemical conversion. In the aftertreatment processes described in patent applications EP 2415796 (US 2012/028022) and EP 2415797 (US 2012/029090), and the as yet unpublished application document DE 10 2012 203737, reaction products of the alkoxylation products prepared according to EP 2 093 244 with isocyanates are described, essentially the reaction of α,ω-dihydroxy-functional alkoxylation products with diisocyanates such as isophorone diisocyanate.

In fact, this chemical reaction is shown to lead to storage-stable products. However, the storage stability thus obtained has a further effect, namely a distinct rise in viscosity, the reasons for which are process-related and will be explained in detail hereinafter.

In a reaction of the terminal α,ω-OH groups of the alkoxylation products with 1 mol of diisocyanate per mole of OH, there is a reaction, in a formal sense, of one isocyanate group of the diisocyanate with an OH group, and the second isocyanate group remains are reacted in the reaction mixture until a further OH group is provided, preferably in the form of a monohydroxy-functional component for NCO depletion. However, the reaction of a diol component with two moles of diisocyanate is not 100% selective, and so, as is known to those skilled in the art, by-products obtained are always reaction products where, for example, two or more diols are joined via one or more diisocyanates. The formation of such by-products can be influenced by many factors, for example the stoichiometries of the individual co-reactants, the type and amount of the catalyst, temperature control, etc., but cannot be avoided entirely.

The alkoxysilyl-functional polymers used in the prior art are essentially high molecular mass polymers. All of the products discussed are based on high molecular mass polyether structures of more than 4000 g/mol, and thus also feature an elevated viscosity. If two (or more) of these high molecular mass polyethers as described in the previous paragraph are then joined via a diisocyanate, this is associated with a significant increase in the viscosity, even if only a few mol % of the polyether chains are joined in such a way. Thus, products having a comparatively high viscosity are obtained. However, a high viscosity of the products is not always desirable and may actually complicate the further formulation of the respective products in the particular case.

There has therefore been no lack of attempts to counteract the high viscosity, particularly in the silylated polyethers, by means of adroit formulation. For instance, the addition of plasticizers to the silylated base polymer, in particular, is a very common method of generating alkoxysilyl-functional polymers of lower viscosity and easier processing quality. The profile of properties may be modified, moreover, through the use of reactive diluents, as described in WO 2011/000843 A2 (US 2012/108730 A1).

This approach to a solution, however, has found only limited acceptance, since the formulator who formulates the base polymer, through having to add defined components intended to influence the viscosity of the formulation, is robbed of an important degree of freedom—namely that of modifying the free formulation according to his or her wishes.

Consequently there is a need for alkoxysilyl-modified polymers which retain without restriction the advantages described above for this class of product, but which at the same time exhibit an adequate shelf life and a low viscosity and can therefore be processed more advantageously.

It was an object of the present invention, accordingly, to prepare compositions comprising alkoxysilyl-modified polymers having lowered reactivity of the terminal OH group(s), which even without assistance from further substances, such as plasticizers or reactive diluents, for example, have lower viscosities, with good processibility, than those of comparable, known compositions comprising alkoxysilyl-modified polymers and simultaneously a long shelf life. A further object of the present invention was to provide a simple process for preparing such compositions, and also the provision of curable compositions of high storage stability, based on such base polymers.

It has now been found that the problem is solved by the introduction of acetoacetate groups at the chain end of the polymer. The present invention therefore provides alkoxylation products containing at least one non-terminal alkoxysilyl group, formed from monomers of at least one alkylene oxide and at least one epoxide bearing alkoxysilyl groups, wherein at least 30% of all the free OH groups on the chain end of the alkoxylation product, corresponding to R¹ and R¹⁷ in the formula (I), have been converted to acetoacetate groups. In a preferred embodiment, at least 40%, preferably at least 45%, more preferably at least 50% and especially preferably at least 60% of all the free OH groups on the chain end of the alkoxylation product have been converted to acetoacetate groups. A particular feature of the alkoxylation products according to the invention is their reduced viscosity compared to known storage-stable alkoxylation products containing at least one non-terminal alkoxysilyl group. Preferred alkoxylation products therefore have a viscosity of ≦25 Pa·s, preferably ≦15 Pa·s, especially preferably ≦10 Pa·s. Preferably, the introduction of the acetoacetate groups in the form of end-capping of the hydroxyl group(s) at the chain end of the prepolymer, prepared by the process disclosed in EP 2 093 244, is effected with a monofunctional reactant. These structures thus modified may be present alone or in a blend with unmodified structures or be used together with further curable compounds of other kinds.

It has been found that, surprisingly, a chemical reaction of the α,ω-hydroxyl groups in the manner of a transesterification or esterification can reduce the reactivity of the OH groups in such a way that the products have adequate shelf life combined with a desirably low viscosity. Compared to products where there is no chemical conversion of the α,ω-hydroxyl groups, it is possible to achieve higher elongation values and higher strengths with the products according to the invention (see also examples). Compared to products where the α,ω-hydroxyl groups have been converted in a different way, it is surprisingly possible to observe the effect that the viscosity of the product remains very substantially unchanged in spite of the transesterification or esterification.

Alkoxylation products having low viscosity with good processibility are understood in the context of this patent application to mean those alkoxysilyl-modified alkoxylation products having a viscosity of ≦25 Pa·s, preferably ≦15 Pa·s, especially preferably ≦10 Pa·s, which have low viscosity with good processibility based not on the addition of one or more auxiliary components to the polymer compositions (after production thereof), but caused solely by the properties of the alkoxylation products according to the invention and of the alkoxylation products prepared by the process according to the invention. Unless explicitly stated otherwise, the viscosity is determined in a shear rate-dependent manner at a shear rate of 10 s⁻¹ and at a temperature of 25° C. with the Anton Paar MCR301 rheometer in a plate-plate arrangement with a gap width of 1 mm. The diameter of the upper plate was 40 mm.

The low viscosity with good processibility has the advantage in particular that there is no need to supply the polymers of the invention with any further viscosity-reducing auxiliary components in order to obtain a good fluidity, and this reduces costs, significantly simplifies the handling of the polymer and, moreover, allows the polymers of the invention to be formulated more freely. Furthermore, the improved fluidity facilitates the preparation process to a particularly high degree, since here as well, with no need for viscosity-reducing auxiliary components, costs can be reduced and a step of addition of viscosity-reducing auxiliary components can be dispensed with.

The present invention additionally provides a process for preparing storage-stable alkoxylation products with low viscosity, with good processibility, as described below.

The present invention further provides storage-stable compositions having low viscosity with good processibility, comprising alkoxylation products prepared by the process according to the invention.

The present invention likewise provides compositions having low viscosity with good processibility, comprising storage-stable alkoxylation products and further components, and the use thereof, especially the use of these storage-stable alkoxylation products having a low viscosity with good processibility in curable compositions.

The alkoxylation products of the invention, the process for preparing them, and their use are described below by way of example, without any intention that the invention should be confined to these exemplary embodiments. When ranges, general formulae or compound classes are specified hereinbelow, these shall include not just the corresponding ranges or groups of compounds that are explicitly mentioned but also all sub-ranges and sub-groups of compounds which can be obtained by extracting individual values (ranges) or compounds. Where documents are cited in the context of the present description, their content shall fully belong to the disclosure content of the present invention particularly in respect of the factual position in the context of which the document was cited. Percentages referred to hereinbelow are by weight unless otherwise stated. Averages referred to hereinbelow are number averages, unless otherwise stated. Where properties of a material are referred to hereinbelow, for example viscosities or the like, these are the properties of the material measured at 25° C., unless stated otherwise.

In the context of the present invention the term “alkoxylation products” or “polyethers” encompasses not only polyethers, polyetherols, polyether alcohols and polyetheresterols but also polyethercarbonate-ols, which may be used synonymously with one another. The term “poly” is not necessarily to be understood as meaning that there are a multiplicity of ether functionalities or alcohol functionalities in the molecule or polymer. It is rather merely used to indicate the presence of at least repeating units of individual monomeric building blocks or else compositions that have a relatively high molar mass and further exhibit a certain polydispersity.

In connection with this invention, the word fragment “poly” encompasses not only exclusively compounds with at least 3 repeat units of one or more monomers in the molecule, but in particular also those compositions of compounds which have a molecular weight distribution and in so doing have an average molecular weight of at least 200 g/mol. This definition takes into account that it is customary in the field of industry in question to refer to such compounds as polymers even if they do not appear to conform to a polymer definition as per OECD or REACH guidelines.

The different fragments in the formula (I) below may be distributed statistically. Statistical distributions may have a blockwise construction with an arbitrary number of blocks and an arbitrary sequence, or may be subject to a randomized distribution; they may also be constructed in alternation or else may form a gradient over the chain; in particular they may also form all hybrid forms in which, optionally, groups with different distributions may follow one another. The formula (I) describes polymers which have a molecular weight distribution. The indices therefore represent the numerical average over all of the monomer units.

The indices a, b, c, d, e, f, g, h, i, w and y that are used in the formulae, and also the value ranges for the specified indices, may be understood as average values of the possible statistical distribution of the structures and/or mixtures thereof that are actually present. This also applies to structural formulae exactly reproduced per se as such, such as for example formula (I).

In the context of this invention, alkoxylation products, preferably of the formula (I), are obtained by the reaction of OH-functional starters and subsequent conversion of the terminal OH groups to esters of the acetoacetates. Preferably, the alkoxylation products having low viscosity with good processibility are those in which the alkoxylation products, preferably of the formula (I), are formed from alkylene oxide, preferably at least ethylene oxide and/or propylene oxide, at least one epoxide bearing alkoxysilyl groups and optionally further monomers, and subsequent reaction with acetoacetate esters or diketene.

Preferred alkoxylation products of the formula (I) are composed of the following monomer fractions: 10 to 97 wt %, preferably 20 to 95 wt %, especially preferably 30 to 90 wt % of propylene oxide, 0 to 60 wt %, preferably 3 to 40 wt %, especially preferably 5 to 30 wt % of ethylene oxide, 0 to 25 wt %, preferably 0.5 to 15 wt %, especially preferably 1 to 10 wt % of epoxide carrying alkoxysilyl groups, and 0 to 25 wt %, preferably 0.1 to 20 wt %, especially preferably 0 to 10 wt % of further monomers, preferably selected from alkylene oxides other than propylene oxide and ethylene oxide, such as butylene oxide, isobutylene oxide, styrene oxide and/or from further comonomers such as ε-caprolactone, phthalic anhydride, glycidyl ethers such as tert-butylphenyl glycidyl ether, C₁₂/C₁₄ fatty alcohol glycidyl ethers and 2-ethylhexyl glycidyl ether, all wt % figures being based on the total weight of the alkoxylation products of formula (I).

The storage-stable alkoxylation products of the invention, of low viscosity with good processibility, preferably correspond to the structure shown in formula (I)

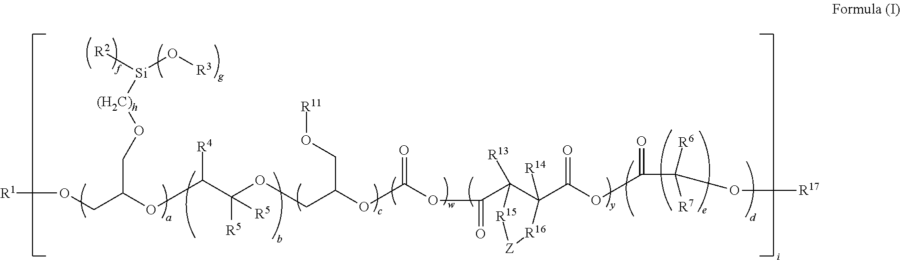

where
a=0 to 100, preferably 1 to 100, and also 1 to 50, more preferably greater than 1 to 10, especially preferably 1 to 5, preferably 1, 2 or 3,
b=0 to 1000, preferably 1 to 500, more preferably greater than 1 to 400, especially preferably 10 to 300,
c=0 to 200, preferably 1 to 100, more preferably greater than 1 to 80, especially preferably 0 to 50,
d=0 to 200, preferably 1 to 100, more preferably greater than 1 to 80, especially preferably 0 to 50,
w=0 to 200, preferably 1 to 100, more preferably greater than 1 to 80, especially preferably 0 to 50,
y=0 to 500, preferably 1 to 300, more preferably 2 to 200 and especially preferably 0 to 100,
e=1 to 10,
f=0 to 2,
g=1 to 3,
with the proviso that g+f=3,
h=0 to 10, preferably 1 to 6, especially preferably 1, 2 or 3,
i=1 to 10, preferably 1 to 5, especially preferably 1, 2 or 3,
with the proviso that the groups with the indices a, b, c, d, w and y are freely permutable over the molecule chain, it being disallowed for each of the groups with the indices w and y to follow itself or the other respective group, and
with the proviso that the various monomer units both of the fragments having the indices a, b, c, d, w and y and of any polyoxyalkylene chain present in the substituent R¹ may be constructed blockwise among one another, it also being possible for individual blocks to occur multiply and to be distributed statistically among one another, or else are subject to a statistical distribution and, moreover, are freely permutable with one another, in the sense of being for arrangement in any desired order, with the restriction that each of the groups of the indices w and y must not follow itself or the other respective group,
   and where
R¹=independently at each occurrence R¹⁷ or a saturated or unsaturated, linear or branched organic hydrocarbon radical which may contain O, S and/or N as heteroatoms; the hydrocarbon radical preferably contains 1 to 400 carbon atoms, preferably 2, 3 or 4 to 200 carbon atoms,
R²=independently at each occurrence an alkyl group having 1 to 8 carbon atoms, especially methyl or ethyl, propyl, isopropyl,
R³=independently at each occurrence an alkyl group having 1 to 8 carbon atoms, especially methyl, ethyl, propyl, isopropyl,
R⁴=independently at each occurrence a hydrogen radical, an alkyl group having 1 to 20 carbon atoms, an aryl or alkaryl group, preferably hydrogen, methyl, ethyl, octyl, decyl, dodecyl, phenyl, benzyl, more preferably hydrogen, methyl or ethyl,
R⁵=independently at each occurrence a hydrogen radical or an alkyl group having 1 to 8 carbon atoms,
   preferably hydrogen, methyl or ethyl, especially preferably hydrogen, or R⁴ and one of the radicals R⁵ may together form a ring which includes the atoms to which R⁴ and R⁵ are bonded, this ring preferably comprising 5 to 8 carbon atoms,
R⁶ and R⁷=independently at each occurrence a hydrogen radical, an alkyl group having 1 to 20 carbon atoms, an aryl or alkaryl group and/or an alkoxy group, preferably a methyl group,
R¹¹=independently at each occurrence a saturated or unsaturated, aliphatic or aromatic hydrocarbon radical having 2 to 30 C atoms, more particularly up to 24 C atoms, which is optionally substituted, being preferably an alkyl group having 1 to 16 carbon atoms, more preferably having 6 to 12 carbon atoms, with a chain which may be interrupted by oxygen and may further carry functional groups, such as, for example, carboxyl groups, esterified optionally with alcohols such as methanol, ethanol, propanol, butanol or hexanol, for example, hydroxyl groups esterified optionally with acids such as acetic acid, butyric acid, neodecanoic acid or (meth)acrylic acid and/or the polymers of (meth)acrylic acid, or an aryl group having 6 to 20 carbon atoms, or an alkaryl group having 7 to 30, preferably 7 to 20, carbon atoms, preferably selected from methyl, ethyl, propyl, butyl, isobutyl, tert-butyl, 2-pentyl, 3-pentyl, 2-methylbutyl, 3-methylbutyl, 2-methyl-2-butyl, 3-methyl-2-butyl, 2,2-dimethylpropyl, hexyl, heptyl, octyl, 2-ethylhexyl, 2-propylheptyl, 2-butyloctanyl, 2-methylundecyl, 2-propylnonyl, 2-ethyldecyl, 2-pentylheptyl, 2-hexyldecyl, 2-butyltetradecyl, 2-dodecylhexadecyl, 2-tetradecyloctadecyl, 3,5,5-trimethylhexyl, isononanyl, isotridecyl, isomyristyl, isostearyl, 2-octyldodecyl triphenylmethyl, C(O)—(CH₂)₅—C—(CH₃)₃ (radical of neodecanoic acid), C₁₂/C₁₄alkyl, phenyl, cresyl, tert-butylphenyl or benzyl group, more preferably a 2-ethylhexyl, C(O)—(CH₂)₅—C—(CH₃)₃— (radical of neodecanoic acid), C₁₂/C₁₄alkyl, phenyl, cresyl or tert-butylphenyl group, very preferably a tert-butylphenyl or 2-ethylhexyl group,

R¹³, R¹⁴=independently at each occurrence hydrogen and/or an organic radical, preferably alkyl, alkenyl, alkylidene, alkoxy, aryl and/or aralkyl groups, or else optionally R¹³ and/or R¹⁴ may be absent, where, when R¹³ and R¹⁴ are absent, there is a C═C double bond in place of the radicals R¹³ and R¹⁴,
the bridging Z fragment may be present or absent,
when the bridging Z fragment is absent, then
R¹⁵ and R¹⁶=independently at each occurrence hydrogen and/or an organic radical, preferably alkyl, alkenyl, alkylidene, alkoxy, aryl and/or aralkyl groups, and, if one of the radicals R¹³ or R¹⁴ is absent, the respective geminal radical (i.e. R¹⁵ if R¹³ is absent and R¹⁶ if R¹⁴ is absent) is an alkylidene radical, preferably methylidene (═CH₂),
   when the bridging Z fragment is present, then
R¹⁵ and R¹⁶=hydrocarbon radicals which are bridged cycloaliphatically or aromatically via the Z fragment, Z representing a divalent alkylene or alkenylene radical which may be further substituted,
   the fragment with the index y may be obtained, for example, by the incorporation of cyclic anhydrides; preferred cyclic anhydrides are succinic anhydride, maleic anhydride, itaconic anhydride, glutaric anhydride, adipic anhydride, citraconic anhydride, phthalic anhydride, hexahydrophthalic anhydride and trimellitic anhydride and also polyfunctional acid anhydrides such as pyromellitic dianhydride, benzophenone-3,3′,4,4′-tetracarboxylic dianhydride, 1,2,3,4-butanetetracarboxylic dianhydride, or radically polymerized homopolymers or copolymers of maleic anhydride with ethylene, isobutylenes, acrylonitrile, vinyl acetate or styrene; particularly preferred anhydrides are succinic anhydride, maleic anhydride, itaconic anhydride, glutaric anhydride, adipic anhydride, citraconic anhydride, phthalic anhydride, hexahydrophthalic anhydride,
R¹⁷=independently at each occurrence hydrogen or a radical of the formula (II)

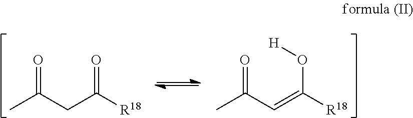

where
R¹⁸=independently at each occurrence a linear or branched, saturated or unsaturated, optionally further-substituted alkyl group having 1 to 30 carbon atoms, or an aryl or alkaryl group, preferably methyl, ethyl, phenyl, more preferably methyl or ethyl,
   and with the proviso that at least 30% of the R¹⁷ radicals correspond to formula (II). Preferably at least 40% of the R¹⁷ radicals correspond to formula (II), further preferably at least 45%, more preferably at least 50% and especially preferably at least 60%. The percentages are of course based here on the total amount of all the R¹⁷ radicals.

Preference is given to storage-stable alkoxylation products of the invention, of low viscosity with good processibility, as per formula (I) in which each of the indices i and a is independently 1, 2, 3 or 4 and b≧3.

Particular preference is given to alkoxylation products of low viscosity with good processibility as per formula (I) with i=2, a=2-4 and b>20 which have been prepared from propylene oxide (PO) and 3-glycidyloxypropyltriethoxysilane (GLYEO) and optionally additionally ethylene oxide (EO). Especial preference is given to alkoxylation products of low viscosity with good processibility as per formula (I) with i=2 which have been prepared from propylene oxide (PO) and 3-glycidyloxypropyltriethoxysilane (GLYEO) and optionally additionally ethylene oxide (EO).

In one especially preferred embodiment, the alkoxylation products of the invention are of the formula (I) where
a=0 to 50, preferably 2 to 20, more preferably 1 to 4,
b=10 to 500, more preferably 12 to 400,
c=0 to 20, preferably 0 to 4
d=0 to 20, preferably 0
w=0 to 20, preferably 0
y=0 to 20, preferably 0,
e=1 to 10,
f=0 to 2
g=1 to 3
with the proviso that g+f=3
h=1, 2 or 3
i=1, 2 or 3 and
R¹=independently at each occurrence R¹⁷ or a saturated or unsaturated, linear or branched organic hydrocarbon radical which may contain O, S and/or N as heteroatoms; the hydrocarbon radical contains preferably 1 to 400 carbon atoms, preferably 2, 3 or 4 to 200 carbon atoms, more preferably, R¹ is R17 or an alkyl radical having 2 to 12, preferably having 3 to 6, carbon atoms, more preferably a butyl radical,
R²=independently at each occurrence a methyl or ethyl, propyl or isopropyl group, preferably a methyl or ethyl group
R³=independently at each occurrence a methyl or ethyl, propyl or isopropyl group, preferably a methyl or ethyl group
R⁴=independently at each occurrence hydrogen or a methyl, ethyl, octyl, decyl, dodecyl, phenyl or benzyl group, more preferably hydrogen or a methyl or ethyl group,
R⁵=independently at each occurrence hydrogen, methyl or ethyl, especially preferably hydrogen,
R¹¹=independently at each occurrence an optionally substituted alkyl chain having 4 to 20 carbon atoms, preferably having 5 to 16 carbon atoms, more preferably having 6 to 12 carbon atoms, preferably selected from methyl, ethyl, propyl, butyl, isobutyl, tert-butyl, octyl, 2-ethylhexyl, 2-propylheptyl, triphenylmethyl, C(O)—(CH₂)₅—C—(CH₃)₃— (radical of neodecanoic acid), C₁₂/C₁₄-alkyl, phenyl, cresyl, tert-butylphenyl or benzyl group, more preferably a 2-ethylhexyl-, C(O)—(CH₂)₅—C—(CH₃)₃— (radical of neodecanoic acid), C₁₂/C₁₄-alkyl, phenyl, cresyl, tert-butylphenyl group, most preferably a tert-butylphenyl or 2-ethylhexyl group,

R¹⁷=independently at each occurrence hydrogen or a radical of the formula (II)

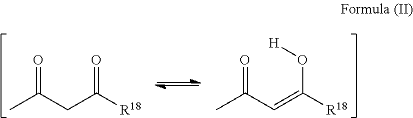

where
R¹⁸=methyl, ethyl or phenyl,
and with the proviso that the percentage (R¹⁷=H)<(R¹⁷=formula (II)).

EP 2 093 244 describes how alkoxysilanes carrying epoxide functions can be selectively alkoxylated advantageously in the presence of known double metal cyanide catalysts. With the process claimed therein, the possibility is provided of performing in a reproducible manner the single and/or multiple alkoxysilyl group modification of polyoxyalkylene compounds not only terminally but also within the sequence of oxyalkylene units. The disclosure content of EP 2 093 244 is considered in full to be part of the present description.

Examples of alkylene oxide compounds that may be used and that result in the fragments with the index a that are specified in formula (I), include ethylene oxide, 1,2-epoxypropane (propylene oxide), 1,2-epoxy-2-methylpropane (isobutylene oxide), epichlorohydrin, 2,3-epoxy-1-propanol, 1,2-epoxybutane (butylene oxide), 2,3-epoxybutane, 2,3-dimethyl-2,3-epoxybutane, 1,2-epoxypentane, 1,2-epoxy-3-methylpentane, 1,2-epoxyhexane, 1,2-epoxycyclohexane, 1,2-epoxyheptane, 1,2-epoxyoctane, 1,2-epoxynonane, 1,2-epoxydecane, 1,2-epoxyundecane, 1,2-epoxydodecane, styrene oxide, 1,2-epoxycyclopentane, 1,2-epoxycyclohexane, vinylcyclohexene oxide, (2,3-epoxypropyl)benzene, vinyloxirane, 3-phenoxy-1,2-epoxypropane, 2,3-epoxy methyl ether, 2,3-epoxy ethyl ether, 2,3-epoxy isopropyl ether, 3,4-epoxybutyl stearate, 4,5-epoxypentyl acetate, 2,3-epoxypropane methacrylate, 2,3-epoxypropane acrylate, glycidyl butyrate, methyl glycidate, ethyl 2,3-epoxybutanoate, 4-(trimethylsilyl)butane 1,2-epoxide, 4-(triethylsilyl)butane 1,2-epoxide, 3-(perfluoromethyl)-1,2-epoxypropane, 3-(perfluoroethyl)-1,2-epoxypropane, 3-(perfluorobutyl)-1,2-epoxypropane, 3-(perfluorohexyl)-1,2-epoxypropane, 4-(2,3-epoxypropyl)morpholine, 1-(oxiran-2-ylmethyl)pyrrolidin-2-one. Preference is given to using ethylene oxide, propylene oxide and butylene oxide. Particular preference is given to using ethylene oxide and propylene oxide.

A non-exhaustive collection of lactones which through ring opening lead to the fragments with the index d, specified in formula (I), are valerolactones or caprolactones, both of which may be unsubstituted or substituted by alkyl groups, preferably methyl groups. Preference is given to using ε-caprolactone or δ-valerolactone, especially ε-caprolactone.

Saturated, unsaturated or aromatic cyclic dicarboxylic anhydrides used, leading to the fragments with the index y specified in formula (I) through reactive incorporation, are preferably succinic anhydride, oct(en)yl-, dec(en)yl- and dodec(en)ylsuccinic anhydride, maleic anhydride, itaconic anhydride, phthalic anhydride, hexahydro-, tetrahydro-, dihydro-, methylhexahydro- and methyltetrahydrophthalic anhydride. During the alkoxylation process, the respective anhydride monomers may be copolymerized in any order and in any variable amount, in succession or in temporal parallel with the epoxide feed, with ring opening, to form polyether esters. Mixtures of the stated anhydrides can also be used. It is possible, furthermore, to add the anhydrides to the starter before the beginning of reaction, and to forgo a metered addition as described above. An alternative possibility, however, is both to add the anhydrides to the starter and to meter in further anhydride in the course of the further reaction, during the alkoxylation.

Particularly preferred for use are succinic anhydride, maleic anhydride, phthalic anhydride and hexahydrophthalic anhydride, especially maleic anhydride and hexahydrophthalic anhydride.

Glycidyl ethers which lead to the fragments specified in formula (I) with the index c conform especially to the general formula (III)

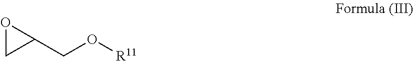

where R¹¹ is as defined above.

The radical R¹¹ may carry further functional groups, such as, for example, (meth)acrylic acid and/or polymers of (meth)acrylic acid. Hydroxyl groups optionally present may therefore be esterified with acrylic acid and/or methacrylic acid. The double bonds of the (meth)acrylic acid are polymerizable, under radical induction for example, UV induction for example.

The polymerization of the (meth)acrylic groups may take place after the preparation of the polyether. It may also be carried out with the alkoxylation products of the invention, with the products of the process of the invention, and also after the inventive use.

R¹¹ conforms preferably to a methyl, ethyl, isobutyl, tert-butyl, hexyl, octyl, 2-ethylhexyl, C(O)—(CH₂)₅—C—(CH₃)₃ (radical from neodecanoic acid, available for example as Cardura E 10 P from Momentive), C₁₂/C₁₄, phenyl, cresyl or tert-butylphenyl group and/or an allyl group, more preferably an ally, cresyl, 2-ethylhexyl, —C(O)—(CH₂)₅—C—(CH₃)₃ or C₁₂/C₁₄ group. Employed with particular preference are 2-ethylhexyl glycidyl ether (available for example as Grilonit RV 1807, Grilonit RV 1807 4.1 or IPDX RD 17) and C₁₂-C₁₄-glycidyl ether (available for example as Ipox® RD 24).

Glycidyl ethers that may be used also include polyfunctional glycidyl ethers such as 1,4-butanediol diglycidyl ether, 1,6-hexanediol diglycidyl ether, cyclohexanedimethanol diglycidyl ether, neopentyl glycol diglycidyl ether, polyethylene glycol diglycidyl ether, polypropylene glycol diglycidyl ether, polyglycerol-3 glycidic ether, glycerol triglycidic ether, trimethylolpropane triglycidyl ether or pentaerythritol tetraglycidyl ether and these allow for the introduction also of branched structural elements into the alkoxylation product of formula (I). Depending on the epoxide-functional alkoxysilane used and on any further monomers employed, modified alkoxylation products of formula (I) can be prepared, and also mixtures of any desired construction.

Alkylene oxide compounds which may be used and which lead to the fragments specified in formula (I) with the index a may conform to the general formula (IV)

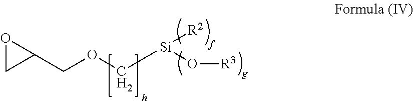

where f, g, h, R² and R³ are as defined above.

A non-exhaustive collection of alkoxysilanes with epoxide groups substitution, of formula (IV), encompasses, for example, 3-glycidyloxypropyltrimethoxysilane, 3-glycidyloxypropyltriethoxysilane, 3-glycidyloxypropyltripropoxysilane, 3-glycidyloxypropyltriisopropoxysilane, bis(3-glycidyloxypropyl)dimethoxysilane, bis(3-glycidyloxypropyl)diethoxysilane, 3-glycidyloxyhexyltrimethoxysilane, 3-glycidyloxyhexyltriethoxysilane, 3-glycidyloxypropylmethyldimethoxysilane, 3-glycidyloxypropylethyldiethoxysilane.

Used preferably in the process of the invention as compounds of the formula (IV) are 3-glycidyloxypropyltrimethoxysilane or -triethoxysilane, which are available, for example, under the trade names DYNASYLAN® GLYMO and DYNASYLAN® GLYEO respectively (trademarks of Evonik Degussa GmbH). Particularly preferred is the use of glycidyloxypropyltriethoxysilane, since in this way it is possible to prevent emissions of methanol in application as moisture-crosslinking components.

The compounds which afford the R¹ radical of the formula (I), in the context of the present invention, are understood to mean substances which at first lead, in step (1) of the process of the invention, to alkoxylation products terminated by hydroxyl groups, which can subsequently be converted in process step (2) to acetoacetate esters.

The R¹ radical originates preferably from a hydroxyl-containing compound of the formula (V)

R¹—(OH)ᵢ (V)

with R¹=organic radical which may optionally have one or more alkoxysilyl groups. The R¹ radical bears i OH groups with i=1 to 8, preferably 1-4, more preferably 1 or 2.

The compound of the formula (V) used in the process of the invention is preferably selected from the group of alcohols, polyetherols or phenols. Employed with preference as starter compound is a mono- or polyhydric polyether alcohol or other alcohol. Employed with preference are mono- to tetrahydric polyether alcohols or other alcohols. Employed with more particular preference are dihydric polyether alcohols or other alcohols. Used advantageously are polyetherols having molar masses of 50 to 2000 g/mol, which have in turn been prepared beforehand by DMC-catalysed alkoxylation.

As well as compounds with aliphatic and cycloaliphatic OH groups, any desired compounds with OH functions are suitable. These include, for example, phenol, alkylphenols and arylphenols.

As starters of the formula (V), it is preferred to use compounds having i=1 to 4 and having molar masses of 62 to 10 000 g/mol, preferably 92 to 7000 g/mol, more preferably 122 to 5000 g/mol and very preferably 2000 to 4000 g/mol. The starter compounds can be used in any desired mixtures with one another or as pure substances. It is also possible to use hydroxyl compounds substituted dependently by substituents containing alkoxysilyl groups, or by alkoxysilyl groups directly, such as the silyl polyethers described in EP 2093244, as starter compounds. Starter compounds used advantageously are low molecular mass polyetherols having molar masses of 62 to 4000 g/mol, which have in turn been prepared beforehand by DMC-catalysed alkoxylation.

As starter of the formula (V) with i=1, it is preferred to use an OH-functional monovalent linear or branched, saturated or unsaturated hydrocarbon radical having 1 to 500 carbon atoms, preferably selected from alkyl, alkenyl, aryl or alkaryl radicals, which may optionally be interrupted by heteroatoms such as O, N and/or S and may also be further substituted, for example by acid ester, amide, alkyl-trialkoxysilane or alkyl-alkyldialkoxysilane groups, the hydrocarbon radical having preferably from 1 to 30, more preferably from 2 to 18 and very preferably from 3 to 12 carbon atoms.

With particular preference, it is possible to use methanol, ethanol, propanol, isopropanol, butanol, isobutanol, tert-butanol, 2,2,4-trimethyl-1,3-pentanediol monoisobutyrate (Texanol from Exxon), octanol, 2-ethylhexanol, 2-propylheptanol, allyl alcohol, decanol, dodecanol, C₁₂/C₁₄ fatty alcohol, phenol, all constitutional isomers of cresol, benzyl alcohol, stearyl alcohol, more particularly butanol, 2,2,4-trimethyl-1,3-pentanediol monoisobutyrate (Texanol from Exxon), allyl alcohol, 2-ethylhexanol or 2-propylheptanol.

In one particular embodiment of the invention, the OH-functional hydrocarbon radical in the starter of formula (V) with i=1 contains 7 to 100 carbon atoms, and the carbon chain of the hydrocarbon radical is preferably interrupted by oxygen atoms; the hydrocarbon radical interrupted by oxygen atoms is preferably a polyoxyalkylene radical, polyether radical and/or polyetheralkoxy radical, or else a polyester, polycarbonate or polyetherester radical, or mixtures of the aforementioned radicals.

As starter of the formula (V) with i=2, it is preferred to use compounds selected from low molecular mass compounds such as ethylene glycol, propylene glycol, di/triethylene glycol, 1,2-propylene glycol, di/tripropylene glycol, neopentyl glycol, 1,4-butanediol, 1,2-hexanediol and 1,6-hexanediol, trimethylolpropane monoethers or glycerol monoethers such as monoallyl ethers, for example, and also from high molecular mass compounds such as polyethylene oxides, polypropylene oxides, polyesters, polycarbonates, polycarbonate polyols, polyester polyols, polyetheresters, polyetherols, polyethercarbonates, polyamides, polyurethanes and sugar-based alkoxylates which may optionally have one or more alkoxysilyl groups.

Starters of formula (V) with i>2 are preferably compounds selected from commercial sugar alcohols such as erythritol, xylitol and especially the hexavalent reduction products of the monosaccharides such as mannitol and sorbitol. Use may also be made, however, of compounds such as trimethylolpropane, di(trimethylol)ethane, di(trimethylol)propane, pentaerythritol, di(pentaerythritol), glycerol, di(glycerol) or polyglycerol, or else other compounds which are based on natural substances and carry hydroxyl groups, such as cellulose sugars or lignin, for example.

Starter compounds used in the process of the invention, R¹—(OH)ᵢ, may preferably be those compounds with i of at least 1 and a melting point of less than 150° C.; more preferably, i is at least 2 and the compound possesses a melting point of less than 100° C. and a molar mass between 500-8000 g/mol; especially preferably, i=2 or 3 and possesses a melting point of less than 90° C. and a molar mass of 500-4000 g/mol.

Preferred starters R¹—(OH)ᵢ are hydroxyl-terminated polyethers which have been prepared by a reaction of propylene oxide, and ethylene oxide, optionally in combination with propylene oxide. All said starters may also be used in any desired mixtures. Particularly preferred starters R¹—(OH)₁ are hydroxyl-containing polyesters such as Desmophen® 1700 (Bayer), polyester polyols, such as Stepanpol® PS-2002 (Stepan Company), Priplast 1838 (Croda), and polycarbonates, as for example Oxymer® M112 (Perstorp), Desmophen® C1200 (Bayer), Desmophen® C2200 (Bayer), and also various dendritic OH-terminated polymers, such as Boltorn® H2004 (Perstorp), for example. Especially preferred starters are polypropylene glycols, polytetrahydrofurans (available in various molar masses as Terathane® (Invista) and PolyTHF® (BASF), e.g. PolyTHF 2000)) and polycarbonates (available in various molar masses as Desmophen® C (Bayer Material Science), e.g. C 1200 or C 2200).

For introduction of the R¹⁷ radical (typically abbreviated to acac), it is possible with preference to use, i.e. as reactants, preferably in process step (2), acetoacetate derivatives of the general formula (VI)

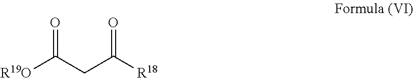

with R¹⁸ as defined above and
R¹⁹=independently at each instance an optionally substituted hydrocarbon radical having 1 to 20 carbon atoms, preferably having 2 to 10 carbon atoms, preferably selected from methyl, ethyl and tert-butyl, especially preferably ethyl and tert-butyl,
   or diketenes of the general formula (VII)

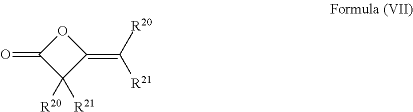

where
R²⁰, R²¹=independently at each instance hydrogen or an optionally substituted hydrocarbon radical having 1 to 20 carbon atoms, preferably methyl, ethyl, benzyl or phenyl.

In the formula (VI), the acetoacetate ester is shown in its keto form. In formula (I), the R¹⁷ radical of formula (II) is also shown in its enol form, more specifically as the keto-enol tautomer. The person skilled in the art is aware that tautomers of this kind are always present in an equilibrium dependent on the constitution of the acetoacetate compound and the polarity of the environment. If compounds of the formula (VI) are referred to hereinafter, the enol forms as shown in formula (II) are always encompassed as well, without this being pointed out explicitly.

Compounds of the formula (VI) used may advantageously be methyl acetoacetate, ethyl acetoacetate, allyl acetoacetate, propyl acetoacetate, isopropyl acetoacetate, butyl acetoacetate, isobutyl acetoacetate, tert-butyl acetoacetate, pentyl acetoacetate, hexyl acetoacetate, heptyl acetoacetate, 2-methoxyethyl acetoacetate, 2-(methacryloyloxy)ethyl acetoacetate, benzyl acetoacetate and mixtures thereof.

Compounds of the formula (VII) used may advantageously be diketene in which the R²⁰ and R²¹ radicals are hydrogen.

The average molar masses M_{w} of the alkoxylation products of formula (I) are preferably between 4000 and 50 000 g/mol, preferably between 8000 and 20 000 g/mol and more preferably from 10 000 to 16 000 g/mol. Preferably, the alkoxylation products of the formula (I) are liquid at room temperature and have a viscosity of ≦25 Pa·s.

The hydrophilicity/hydrophobicity in the alkoxylation products of the invention may be adjusted through the choice of suitable starter molecules and/or of suitable comonomers for the alkoxylation.

The alkoxylation products of the invention can be obtained in a variety of ways. The alkoxylation products of the invention are prepared preferably by the process of the invention that is described below.

The alkoxylation products of the formula (I) are notable in that in terms of structural make-up and molar mass they can be produced in a targeted and reproducible way. The sequence of the monomer units may be varied within wide limits. Epoxide monomers may be incorporated in arbitrarily blocklike fashion arrayed with one another or statistically into the polymer chain. The sequence of the fragments inserted into the resultant polymer chain through the ring-opening reaction of the reaction components is freely permutable among the fragments, in the sense of a possibility for arrangement in any desired order, with the restriction that cyclic anhydrides and also carbon dioxide are inserted statistically, in other words not in homologous blocks, in the polyether structure, and also not directly adjacent to one another.

The index numbers reproduced here and the value ranges for the indices indicated in the formulae shown here are therefore understood as average values of the possible statistical distribution of the structures and/or mixtures thereof that are actually present. This also applies to those structural formulae exactly reproduced per se, such as for example formula (I).

Depending on the epoxide-functional alkoxysilane used and any further monomers employed, and also any carbon dioxide, it is possible to obtain ester-modified or carbonate-modified alkoxysilyl polyethers. The alkoxysilyl unit in the compound of the formula (I) is preferably a trialkoxysilyl unit, more particularly triethoxysilyl unit.

As shown by ²⁹Si NMR and GPC investigations, the process-related presence of chain-end OH groups means that transesterification reactions on the silicon atom are possible not only during the DMC-catalysed preparation but also, for example, in a subsequent process step. In that case, formally, the alkyl radical R³ bonded to the silicon via an oxygen atom is replaced by a long-chain, modified alkoxysilyl polymer radical. Bimodal and multimodal GPC plots demonstrate that the alkoxylation products include not only the untransesterified species, as shown in formula (I), but also those with twice, in some cases three times, or even four times the molar mass. Formula (I) therefore provides only a simplified representation of the complex chemical reality.

The alkoxylation products therefore constitute mixtures, which may also include compounds in which the sum of the indices f+g in formula (I) is on average less than 3, since some of the R³O groups may be replaced by silyl polyether groups. The compositions therefore comprise species which are formed on the silicon atom with elimination of R³—OH and condensation reaction with the reactive OH group of a further molecule of the formula (I). This reaction may proceed multiply until, for example, all of the R³O groups on the silicon have been replaced by further molecules of the formula (I). The presence of more than one signal in typical ²⁹Si NMR spectra for these compounds underlines the occurrence of silyl groups with different substitution patterns.

The stated values and preference ranges for the indices a, b, c, d, e, f, g, h, i, w and y in the compound of the formula (I) should therefore be understood as average values across the various, individually intangible species. The diversity of chemical structures and molar masses is also reflected in the broad molar mass distributions of M_{w}/Mₙ of mostly ≧1.5, which are typical for alkoxylation products of the formula (I) and entirely unusual for conventional DMC-based polyethers.

The alkoxylation products of the invention are preferably prepared by the process of the invention as described below.

The present invention therefore further provides processes for preparing the above-described alkoxylation products, wherein at least one alkylene oxide is reacted with at least one epoxide bearing alkoxysilyl groups and optionally further monomers, and the product thus obtained is reacted with acetoacetate esters and/or diketene.

The process of the invention for preparing alkoxylation products having low viscosity with good processibility, as per formula (I), preferably comprises the steps of
(1) reacting at least one starter R¹—(OH)ᵢ, preferably selected from the group of the alcohols, polyetherols and phenols with at least one alkylene oxide and at least one epoxide bearing alkoxysilyl groups, and
(2) reacting the OH-terminated alkoxylation product from step (1) with at least one acetoacetate ester or diketene,
   wherein starters are OH-functional compounds and the alkylene oxides and reactants are those defined above as preferred. Preferably, step (2) takes place directly after conclusion of the completed alkoxylation in step (1).

### Process Step (1):

In process step (1), preferably, a DMC-catalysed alkoxylation of a starter of formula (V) with compounds having epoxy groups (alkylene oxides and glycidyl ethers) according to EP 2 093 244 is conducted. In process step (1), an alkoxysilyl-functional of formula (I) with R¹⁷=H is thus obtained, meaning that hydroxyl groups are present at the chain terminus/chain termini (according to the value of i). These have originated from the epoxide ring opening of the last epoxide monomer in each case with linkage to the OH-functional end of the growing chain.

In order to start the alkoxylation reaction according to the process of the invention, the starting mixture, consisting of one or more OH-functional starter(s) of formula (V) and the double metal cyanide catalyst, which optionally has been suspended beforehand in a suspension medium, is charged to the reactor.

Suspension media utilized may be either a polyether or inert solvents or else, advantageously, one or more starting compounds, or alternatively a mixture of both components.

Propylene oxide or at least one other epoxide compound is metered into the starting mixture introduced. To start the alkoxylation reaction and to activate the double metal cyanide catalyst, generally only some of the total amount of epoxide to be metered in is initially added. The molar ratio of epoxide to the reactive groups in the starter, more particularly to the OH groups in the starting mixture, is in the starting phase preferably between 0.1:1 to 10:1, preferably between 0.2:1 to 5:1, preferably between 0.4:1 to 3:1. It may be advantageous if, before the epoxide is added, any reaction-inhibiting substances that may be present are removed from the reaction mixture, by means of distillation, for example, optionally under reduced pressure.

The start of the exothermic reaction may be detected by monitoring pressure and/or temperature for example. In the case of gaseous alkylene oxides, a sudden drop in pressure in the reactor indicates that the alkylene oxide is being incorporated, that the reaction has thus started and that the end of the start phase has been reached. In the case of non-gaseous glycidyl ethers/esters or epoxy-functional alkoxysilanes, the onset of the reaction is preferably indicated by the enthalpy change which occurs.

After the start phase, i.e. after initialization of the reaction, further alkylene oxide may be metered in depending on the molar mass sought. An alternative possibility is to add on an arbitrary mixture of different alkylene oxide compounds and compounds of the formulae (III) and (IV), which may also be added on separately in any order in succession.

The reaction may be performed in an inert solvent, for example to reduce the viscosity of the reaction mixture. Suitable inert solvents include hydrocarbons, especially toluene, xylene or cyclohexane. However, this is less preferred.

In the products of the invention, the molar ratio of the sum of the metered epoxides, including the epoxides already added in the starting phase, based on the starting compound employed, more particularly based on the number of OH groups in the starting compound employed, is preferably 1 to 10⁵:1, more particularly 1 to 10⁴:1.

The addition of the alkylene oxide compounds occurs preferably at a temperature of 60 to 250° C., more preferably at a temperature of 90 to 160° C. The pressure at which the alkoxylation takes place is preferably 0.02 bar to 100 bar, more preferably 0.05 to 20 bar and more particularly from 0.2 to 2 bar absolute. By carrying out the alkoxylation at sub-atmospheric pressure it is possible to implement the reaction very safely. The alkoxylation may optionally be carried out in the presence of an inert gas (e.g. nitrogen) or—for producing polyethercarbonates—in the presence of carbon dioxide in this case also at a positive pressure of from preferably 1 to 20 bar absolute.

The cyclic anhydrides or lactones which can be used for the preparation of ester-modified polyethers may be added not only in the actual starting phase to the mixture of starter of formula (V) and catalyst, but also at a later point in time, in parallel with the alkylene oxide feed. The comonomers mentioned can also each be metered into the reactor in alternating succession with alkylene oxides.

Here, the molar ratio of the alkylene oxide monomers to cyclic anhydrides may be varied. Based on anhydrides, at least equimolar amounts of alkylene oxide monomers are typically employed. Preference is given to using the alkylene oxides in a molar excess in order to ensure full anhydride conversion.

Lactones may be added during the alkoxylation either in stoichiometric deficiency or excess based on the alkylene oxide monomers.

After the monomer addition and any further reaction to complete the monomer conversion, any residues of unreacted monomer and any further volatile constituents are removed, typically by vacuum distillation, gas stripping or other deodorization methods. Volatile secondary components may be removed either discontinuously (batchwise) or continuously. In the DMC catalysis-based process according to the invention, filtration may normally be eschewed.

The process steps may be performed at identical or different temperatures. The mixture of starting substance, DMC catalyst and optionally suspension medium that is charged to the reactor at the start of the reaction may be pretreated by stripping in accordance with the teaching of WO 98/52689 before monomer metering is commenced. This comprises admixing an inert gas with the reaction mixture via the reactor feed and removing relatively volatile components from the reaction mixture by application of negative pressure using a vacuum plant connected to the reactor system. In this simple fashion, substances which may inhibit the catalyst, such as lower alcohols or water for example, can be removed from the reaction mixture. The addition of inert gas and the simultaneous removal of the relatively volatile components may be advantageous particularly at reaction start-up, since the addition of the reactants, or secondary reactions, may also introduce inhibiting compounds into the reaction mixture.

Double metal cyanide catalysts (DMC catalysts) used in the process of the invention are preferably those described in EP 2 093 244, more particularly the DMC catalysts described therein as preferred and particularly preferred, respectively.

The catalyst concentration in the reaction mixture is preferably from >0 to 1000 wppm (mass ppm), preferably from >0 to 500 wppm, more preferably from 0.1 to 300 wppm and most preferably from 1 to 200 wppm. This concentration is based on the total mass of the alkoxylation products formed.

The catalyst is preferably metered into the reactor only once. The amount of catalyst is to be set such that sufficient catalytic activity is provided for the process. The catalyst may be metered in as solid or in the form of a catalyst suspension. If a suspension is used, then a particularly suitable suspension medium is the starter of formula (V). Preferably, however, there is no suspending.

It may be advantageous if process step (1) of the process of the invention is carried out such that the alkoxylation is carried out in at least three stages. In this case, in stage 1, the starter is reacted with a small amount of propylene oxide in the presence of the DMC catalyst as described above. Subsequently, further propylene oxide is added on, with the consequent and preferred development of at most a molar mass of 500 to 10 000 g/mol, and more preferably of at most 1000 to 3000 g/mol, in addition to the starter used. In stage 2, further propylene oxide and/or ethylene oxide and optionally one or more of the abovementioned glycidyl ethers of the formula (III) are added; in stage 3, one or more of the compounds of the formula (IV) is or are added, optionally with further addition of propylene oxide and/or ethylene oxide; stages 2 and 3 may also be combined to form one stage.

By adding on a mixture of compound of the formula (IV) and propylene oxide in stage 3, the alkoxysilane functionality is introduced randomly over the polymer chains/polymer blocks. The sequence in which stages 2 and 3 are carried out is arbitrary. Preferably, after stage 1, stage 2 is carried out first, before stage 3 is carried out. Stages 2 and 3 may be carried out multiply in succession. If stages 2 and 3 are carried out for a number of times, the alkylene oxides used, and also the components of the formulae (III) and (IV), may be the same or different. The detailed process description above serves merely for better illustration, and represents a preferred metering sequence of the reactants. It must not be used to imply any strictly blockwise construction of the alkoxylation products of the invention with reduced viscosity.

Stage 1 is carried out preferably at a temperature of 70-160° C., more preferably at 80−150° C., very preferably at a temperature of 100-145° C., especially preferably at 110−130° C. Stage 2 is carried out preferably at a temperature of 70-160° C., more preferably at 80−150° C., very preferably at a temperature of 100-145° C., especially preferably at 110−130° C. Stage 3 is carried out preferably at a temperature of 70-140° C., more preferably at 75−120° C., very preferably at a temperature of 80-110° C. If stages 2 and 3 are combined, the reaction temperature should be adapted to the temperature preferred under stage 3.

Preferably, the alkylene oxides in process step (1) are ethylene oxide and/or propylene oxide and at least one epoxide bearing alkoxysilyl groups and/or further monomers. Monomers are used preferably in the following fractions: 10 to 97 wt %, preferably 20 to 95 wt %, especially preferably 30 to 90 wt % of propylene oxide, 0 to 60 wt %, preferably 3 to 40 wt %, especially preferably 5 to 30 wt % of ethylene oxide, 0 to 25 wt %, preferably 0.5 to 15 wt %, especially preferably 1 to 10 wt % of epoxide carrying alkoxysilyl groups, and 0 to 25 wt %, preferably 0.1 to 20 wt %, especially preferably 0 to 10 wt % of further monomers, preferably selected from alkylene oxides other than propylene oxide and ethylene oxide, such as butylene oxide, isobutylene oxide, styrene oxide, and/or further comonomers such as ε-caprolactone, phthalic anhydride, glycidyl ethers such as tert-butylphenyl glycidyl ether, C₁₂/C₁₄ fatty alcohol glycidyl ethers and 2-ethylhexyl glycidyl ether, based on the total weight of the monomers used. More particularly, monomers of this kind and the proportions specified lead to storage-stable products of particularly low viscosity. Products of this kind therefore have good further processibility.

Preferably, the products of the invention are obtainable by alkoxylation process using double metal cyanide catalysts (DMC catalysts) and dihydroxy-functional compounds as starters of formula (V) with i=2.

Preferably, the alkoxylation products of the invention are obtainable by subjecting starters of this kind to the addition of at least one glycidyl ether of the general formula (IV) and at least one further polymerizable monomer, preferably selected from alkylene oxides, glycidyl ethers, cyclic dicarboxylic anhydride and mixtures thereof, especially alkylene oxides, more preferably monomers which lead, in the finished product, the fragments having the index b, c, d, w and/or y, especially preferably fragments having the index b, of the formula (I).

### Process Step (2):

In process step (2), there is an end-capping reaction in which the OH-terminated alkoxylation products from step (1) are reacted with at least one reactant in such a way that the reactivity of the hydroxyl groups is reduced to such a degree that storage-stable products are obtained for the intended product applications.

In order then to obtain alkoxylation products of formula (I) with R¹⁷=formula (II), many reactions are conceivable, and these are described inter alia in “Acetic Acid and its Derivatives”, V. H. Agreda, J. R. Zoeller (Eds.), Marcel Dekker Inc., New York 1993, chapter 11. The reactants used may, for example, be diketene (formula (VII)), which can add onto the terminal hydroxyl group of the product from process step (1). A particularly advantageous feature of such a reaction is that no elimination product arises, which may be troublesome in the subsequent use and thus may have to be removed by distillation.

Alternatively, the reaction can also be effected by a transesterification if reactants used are compounds such as alkyl, aryl or alkyl acetoacetates, for example. Acetoacetate esters of this kind may correspond to the compounds represented in formula (VI), preference being given to methyl, ethyl, allyl, tert-butyl, phenyl and benzyl acetoacetate.

More preferably, for economic and process technology reasons, ethyl acetoacetate and tert-butyl acetoacetate are used. As well as its availability on the industrial scale, ethyl acetoacetate is also notable for an advantageous price. tert-Butyl acetoacetate has the process technology advantage of having a high selectivity for the purposes of conducting the reaction as a result of the high steric demands of the tert-butyl group. Since an esterification is always an equilibrium reaction, the hydrolysis of the acetoacetate esters generated is hindered by the steric demands of the tert-butanol hydrolysis alcohol generated beforehand and hence results in a higher reaction rate compared to other esters such as methyl or ethyl acetoacetate.

Compounds of the formula (VI) and/or the formula (VII) used in process step (2) may advantageously be diketene, methyl acetoacetate, ethyl acetoacetate, allyl acetoacetate, propyl acetoacetate, isopropyl acetoacetate, butyl acetoacetate, isobutyl acetoacetate, tert-butyl acetoacetate, pentyl acetoacetate, hexyl acetoacetate, heptyl acetoacetate, 2-methoxyethyl acetoacetate, 2-(methacryloyloxy)ethyl acetoacetate, benzyl acetoacetate and mixtures thereof. Particular preference is given to diketene, methyl acetoacetate, ethyl acetoacetate, allyl acetoacetate, isobutyl acetoacetate, tert-butyl acetoacetate, benzyl acetoacetate and mixtures thereof; especially preferred are ethyl acetoacetate and/or tert-butyl acetoacetate.

The tert-butyl acetoacetate raw material (CAS 1694-31-1) is supplied, for example, by Lonza under the AA-t-butyl product name and by Eastman under the Eastman™ t-BAA name. The ethyl acetoacetate raw material (CAS 141-97-9) is supplied, for example, by Lonza under the EAA product name and by Eastman under the Eastman™ EAA name.

Process step (2) of the process of the invention can preferably be conducted at temperatures of 50° C. to 150° C., more preferably at temperatures of 70° C. to 120° C. and especially preferably at temperatures of 90° C. and 110° C. The pressure at which process step (2) is conducted is preferably 0.02 bar to 100 bar, more preferably 0.05 to 20 bar and especially from 0.2 to 1 bar absolute.

In a particular embodiment of the process of the invention, it may be advantageous to conduct process step (2) under reduced pressure and to continuously remove the hydrolysis alcohol released in the transesterification by distillation.

As result of the presence of the moisture-sensitive alkoxysilyl groups in the alkoxylation product of process step (1), it may be advantageous to conduct process step (2) in the presence of an inert gas, for example nitrogen or argon.

Process step (2) of the process of the invention can be conducted in the absence or presence of a solvent. Useful solvents are in principle all the solvents that are inert under the reaction conditions chosen. However, it is preferable to conduct process step (2) of the process of the invention in the absence of solvents, in order to of avoid any need to remove the solvent by distillation.

Process step (2) of the process of the invention can be conducted in the absence or presence of a catalyst. Suitable catalysts are in principle all the esterification or transesterification catalysts known to those skilled in the art; it is advantageously possible to use transition metal catalysts, for example organotin or organotitanium catalysts.

To avoid unwanted side reactions of the alkoxysilyl groups, preference is given to a catalyst-free reaction in process step (2).

Preferably, in the process of the invention, the reactants of the formulae (VI) and (VII) are used at least in equimolar amounts relative to the OH groups in the intermediate alkoxylation product from process step (1).

More preferably, in the process of the invention, the reactants of the formulae (VI) and (VII) are used in a molar excess relative to the OH groups in the intermediate alkoxylation product from process step (1).

In another particularly preferred embodiment of process step (2) for preparing the alkoxylation products of the invention of the formula (I), the aim is for a quantitative conversion not only of the terminal OH functions of the polyether but also of the reactants of the formulae (VI) and (VII).

In addition, in the particularly preferred embodiment of process step (2) of the process of the invention, the reaction conditions are chosen such that, in the composition, more alkoxylation products of formula (I) with R¹⁷=formula (II) are present as a percentage than with R¹⁷=H.

It is possible to influence the degree of conversion, i.e. the ratio of R¹⁷=formula (II) to R¹⁷=H in the alkoxylation product of formula (I), according to the reaction conditions and nature of the reactants. It may be advantageous if process step (2) is conducted such that >20 wt %, preferably >50 wt % and more preferably >75 wt % of the alkoxylation products of the formula (I) obtained bear terminal radicals of the formula (II). The use of 1.0 to 1.5 molar equivalents of acetoacetate ester or diketene, based on the number of free OH groups in the alkoxylation product from process step (1), in process step (2) and reaction at temperatures of 80-140° C., preferably 90-120° C., for at least 1.5 hours leads, for example, to products in which >30 wt % of the alkoxylation products obtained bear terminal radicals of the formula (II), and the use of 1.2 to 2 molar equivalents of acetoacetate ester or diketene, based on the number of free OH groups in the alkoxylation product from process step (1), in process step (2) and reaction at temperatures of 80-140° C., preferably 90-120° C., for at least 2.5 hours leads, for example, to products in which >60 wt % of the alkoxylation products obtained bear terminal radicals of the formula (II).

The alkoxylation products of the invention may be used, for example, for producing curable compositions.

A feature of curable compositions of the invention is that they comprise one or more of the above-described alkoxylation products of the invention, of the formula (I), and at least one curing catalyst.

The alkoxylation products of the invention preferably correspond to the formula (I) with i=2, a=1 to 4 and b=3 to 300 and preferably c=0, w=0, y=0 and d=0. More preferably, the monomers which lead to the unit with the index b are ethylene oxide and/or propylene oxide. Especially preferably, the proportion of propylene oxide is 10 to 99 wt %, preferably 20 to 80 wt %, likewise preferably 40 to 60 wt % and most preferably 80 to 99 wt %, and the proportion of ethylene oxide is 0 to 60 wt %, preferably 5 to 50 wt %, likewise preferably 10 to 20 wt % and most preferably 0 to 20 wt %, based on the total amount of monomers used. Further preferably, the monomers which lead to the unit having the index a are those bearing exclusively ethoxysilyl groups, preferably triethoxysilyl groups, more preferably 3-glycidyloxypropyltriethoxysilane (GLYEO). It is particularly preferable when a combination of the aforementioned preferred properties of the alkoxylation product is effected.

The fraction of the alkoxylation products of the invention in compositions of the invention is preferably from 10 to 90 wt %, preferably from 15 to 70 wt % and more preferably from 20 wt % to 65 wt %.

Curing catalysts used (for the crosslinking or polymerization of the composition of the invention or for the chemical attachment thereof to particle surfaces or macroscopic surfaces) may be the catalysts typically employed for the hydrolysis and condensation of alkoxysilanes. Curing catalysts employed with preference are organotin compounds, such as, for example, dibutyltin dilaurate, dibutyltin diacetylacetonate, dibutyltin diacetate, dibutyltin dioctoate, or dioctyltin dilaurate, dioctyltin diacetylacetonate, dioctyltin diketanoate, dioctylstannoxane, dioctyltin dicarboxylate, dioctyltin oxide, preferably dioctyltin diacetylacetonate, dioctyltin dilaurate, dioctyltin diketanoate, dioctylstannoxane, dioctyltin dicarboxylate, dioctyltin oxide, more preferably dioctyltin diacetylacetonate and dioctyltin dilaurate. Also used, furthermore, may be zinc salts, such as zinc octoate, zinc acetylacetonate and zinc-2-ethylcaproate, or tetraalkylammonium compounds, such as N,N,N-trimethyl-N-2-hydroxypropylammonium hydroxide, N,N,N-trimethyl-N-2-hydroxypropylammonium 2-ethylhexanoate or choline 2-ethylhexanoate. Preference is given to the use of zinc octoate (zinc 2-ethylhexanoate) and of the tetraalkylammonium compounds, particular preference to that of zinc octoate. Use may further be made of bismuth catalysts as well, e.g. Borchi® catalysts, titanates, e.g. titanium(IV) isopropoxide, iron(III) compounds, e.g. iron(III) acetylacetonate, aluminium compounds, such as aluminium triisopropoxide, aluminium tri-sec-butoxide and other alkoxides and also aluminium acetylacetonate, calcium compounds such as calcium disodium ethylenediamine tetraacetate or calcium diacetylacetonate, or else amines, e.g. triethylamine, tributylamine, 1,4-diazabicycl[2.2.2]octane, 1, 8-diazabicyclo[5.4.0]undec-7-ene, 1,5-diazabicyclo[4.3.0]non-5-ene, N,N-bis(N,N-dimethyl-2-aminoethyl)methylamine, N,N-dimethyl cyclohexylamine, N,N-dimethylphenylamine, N-ethylmorpholine etc. Organic or inorganic Brønsted acids as well, such as acetic acid, trifluoroacetic acid, methanesulphonic acid, p-toluenesulphonic acid or benzoyl chloride, hydrochloric acid, phosphoric acid, its monoesters and/or diesters, such as butyl phosphate, (iso)propyl phosphate, dibutyl phosphate, etc., for example, are suitable as catalysts. It is of course also possible to employ combinations of two or more catalysts.

The fraction of the curing catalysts in the composition of the invention is preferably from 0.1 wt % to 5 wt %, more preferably from 0.15 to 2 wt % and very preferably from 0.2 to 0.75 wt %, based on the overall composition.

The composition of the invention may comprise further adjuvants selected from the group of plasticizers, fillers, solvents, adhesion promoters, additives for modifying the flow behaviour, known as rheology additives, and drying agents, more particularly chemical moisture-drying agents.

The composition of the invention preferably comprises one or more adhesion promoters and/or one or more drying agents, more particularly chemical moisture-drying agents.

As adhesion promoters it is possible for the adhesion promoters known from the prior art, more particularly aminosilanes to be present in the composition of the invention. Adhesion promoters which can be used are preferably compounds which carry alkoxysilyl groups and which additionally possess primary or secondary amine groups, vinyl groups, thio groups, aryl groups or alternatively oxirane groups, such as 3-aminopropyltrimethoxysilane (Dynasylan® AMMO (Evonik)), N-(2-aminoethyl)-3-aminopropyltrimethoxysilane (Dynasylan® DAMO (Evonik)), N-(n-butyl)aminopropyltrimethoxysilane (Dynasylan® 1189 (Evonik)), 3-mercaptopropyltrimethoxysilane (Dynasylan® MTMO, Evonik), 3-® glycidyloxypropyltriethoxysilane (Dynasylan® GLYEO, Evonik) 3-glycidyloxypropyltrimethoxysilane (Dynasylan® GLYMO, Evonik), phenyltrimethoxysilane (Dynasylan® 9165 or Dynasylan® 9265, Evonik) or oligomeric amino/alkyl-alkoxysilanes such as, for example, Dynasylan® 1146 (Evonik), in each case alone or in a mixture. Adhesion promoters preferably present are, for example, 3-aminopropyltriethoxysilane (Geniosil® GF 93 (Wacker), Dynasylan® AMEO (Evonik®)) and/or (3-aminopropyl)methyldiethoxysilane (Dynasylan® 1505 (Evonik®)), 3-aminopropyltrimethoxysilane (Dynasylan® AMMO (Evonik)), N-(2-aminoethyl)-3-aminopropyltrimethoxysilane (Dynasylan® DAMO (Evonik)), Dynasylan® 1146 (Evonik), more preferably 3-aminopropyltriethoxysilane, 3-aminopropyltrimethoxysilane, N-(2-aminoethyl)-3-aminopropyltrimethoxysilane, Dynasylan® 1146, and especially preferably 3-aminopropyltrimethoxysilane, 3-aminopropyltriethoxysilane, N-(2-aminoethyl)-3-aminopropyltrimethoxysilane and Dynasylan® 1146. The fraction of the adhesion promoters in the composition of the invention is preferably from greater than 0 to 5 wt %, more preferably from 0.5 to 4 wt % and very preferably from 1 to 2.5 wt %, based on the overall composition. It may be advantageous if the composition of the invention comprises a drying agent, in order, for example to bind moisture or water introduced by formulation components, or incorporated subsequently by the filling operation or by storage. Drying agents which can be used in the compositions of the invention are in principle all of the drying agents known from the prior art. Chemical drying agents which can be used include, for example, vinyltrimethoxysilane (Dynasylan® VTMO, Evonik or Geniosil® XL 10, Wacker AG), vinyltriethoxysilane (Dynasylan® VTEO, Evonik or Geniosil® GF 56, Wacker), vinyltriacetoxysilane (Geniosil® GF 62, Wacker), N-trimethoxysilylmethyl O-methylcarbamate (Geniosil® XL 63, Wacker), N-dimethoxy(methyl)silylmethyl O-methylcarbamate, N-methyl[3-(trimethoxysilyl)propyl]carbamate (Geniosil® GF 60, Wacker), vinyldimethoxymethylsilane (Geniosil® XL 12, Wacker), vinyltris(2-methoxyethoxy)silane (Geniosil® GF 58, Wacker), bis(3-triethoxysilylpropyl)amine (Dynasylan® 1122, Evonik), bis(3-trimethoxysilylpropyl)amine (Dynasylan®) 1124), N-dimethoxy(methyl)silylmethyl O-methylcarbamate (Geniosil® XL 65, Wacker) or oligomeric vinylsilanes such as, for example, Dynasylan® 6490 and Dynasylan® 6498 (both acquirable from Evonik) alone or in a mixture. Preference is given to using vinyltrimethoxysilane (Dynasylan® VTMO, Evonik or Geniosil® XL 10, Wacker AG), vinyltriethoxysilane (Dynasylan® VTEO, Evonik or Geniosil® GF 56, Wacker) as drying agents. As a chemical moisture-drying agent, the composition of the invention comprises preferably vinyltrimethoxysilane (Dynasylan® VTMO, Evonik or Geniosil® XL 10, Wacker AG). Furthermore, in addition to or as an alternative to the chemical drying, a physical drying agent may be used, such as zeolites, molecular sieves, anhydrous sodium sulphate or anhydrous magnesium sulphate, for example.

The fraction of the drying agent in the composition of the invention is preferably from greater than 0 to 5 wt %, more preferably from 0.2 to 3 wt %, based on the overall composition.

The composition of the invention may comprise one or more adjuvants selected from the group of plasticizers, fillers, solvents and additives for adapting the flow behaviour (rheology additives).

The plasticizers may for example be selected from the group of the phthalates, the polyesters, alkylsulphonic esters of phenol, cyclohexanedicarboxylic esters, or else of the polyethers. Plasticizers used are only those compounds which are different from the alkoxylation products of the invention of the formula (I).

If plasticizers are present in the composition of the invention, the fraction of the plasticizers in the composition of the invention is preferably from greater than 0 wt % to 90 wt %, more preferably 2 wt % to 70 wt %, very preferably 5 wt % to 50 wt %, based on the overall composition.

Fillers which can be used are, for example, precipitated or ground chalk, inorganic carbonates in general, precipitated or ground silicates, precipitated or fumed silicas, glass powders, hollow glass beads (known as bubbles), metal oxides, such as TiO₂, Al₂O₃, for example, natural or precipitated barium sulphates, reinforcing fibers, such as glass fibers or carbon fibers, long or short fiber wollastonites, cork, carbon black or graphite. With advantage it is possible to use hydrophobized fillers, since these products exhibit lower introduction of water and improve the storage stability of the formulations.

If fillers are present in the composition of the invention, the fraction of the fillers in the composition of the invention is preferably from 1 to 70 wt % based on the overall composition, with concentrations of 30 to 65 wt % being particularly preferred for the fillers stated here, with the exception of the fumed silicas. If fumed silicas are used, a particularly preferred fumed silica fraction is from 2 to 20 wt %.

As rheology additives, preferably present in addition to the filler, it is possible to select from the group of the amide waxes, acquirable for example from Cray Valley under the brand name Crayvallac®, hydrated vegetable oils and fats, fumed silicas, such as Aerosil® R202 or R805 (both acquirable from Evonik) or Cab-O-Sil® TS 720 or TS 620 or TS 630 (sold by Cabot), for example. If fumed silicas are already being used as a filler, there may be no need to add a rheology additive.

If rheology additives are present in the composition of the invention, the fraction of the rheology additives in the composition of the invention, depending on the desired flow behaviour, is preferably from greater than 0 wt % to 10 wt %, more preferably from 2 wt % to 6 wt %, based on the overall composition.

The compositions of the invention may comprise solvents. These solvents may serve, for example, to lower the viscosity of the uncrosslinked mixtures, or may promote flow onto the surface. Solvents contemplated include in principle all solvents and also solvent mixtures. Preferred examples of such solvents are ethers such as, tert-butyl methyl ether, esters, such as ethyl acetate or butyl acetate or diethyl carbonate, and also alcohols, such as methanol, ethanol and also the various regioisomers of propanol and of butanol, or else glycol types, which are selected according to the specific application. Furthermore, aromatic and/or aliphatic solvents may be employed, including halogenated solvents as well, such as dichloromethane, chloroform, carbon tetrachloride, hydrofluorocarbons (FREON), etc., and also inorganic solvents such as, for example, water, CS₂, supercritical CO₂ etc.

As and when necessary, the compositions of the invention may further comprise one or more substances selected from the group encompassing co-crosslinkers, flame retardants, deaerating agents, antimicrobial and preservative substances, dyes, colorants and pigments, frost preventatives, fungicides and/or reactive diluents and also complexing agents, spraying assistants, wetting agents, fragrances, light stabilizers, radical scavengers, UV absorbers and stabilizers, especially stabilizers against thermal and/or chemical exposures and/or exposures to ultraviolet and visible light.

UV stabilizers used may be, for example, known products based on hindered phenolic systems. Light stabilizers used may be, for example, those known as HALS amines. Stabilizers which may be used include, for example, the products or product combinations known to the skilled person and made up for example of Tinuvin®-stabilizers (Ciba), such as Tinuvin® stabilizers (Ciba), for example Tinuvin® 1130, Tinuvin® 292 or else Tinuvin® 400, preferably Tinuvin® 1130 in combination with Tinuvin® 292. The amount in which they are used is guided by the degree of stabilization required.

In addition, the curable compositions may be admixed with co-crosslinkers in order to boost mechanical hardness and reduce the propensity to flow. Such co-crosslinkers are typically substances capable of providing 3, 4 or more crosslinkable groups. Examples in the context of this invention are 3-aminopropyltriethoxysilane, tetramethoxysilane or tetraethoxysilane.

Preferred compositions of the invention comprise at least one alkoxylation product of the formula (I) and a plasticizer, a filler, an adhesion promoter, a drying agent or a (curing) catalyst.

Particularly preferred compositions of the invention have from 10 to 90 wt % or less than 80 wt %, based on the overall composition, of alkoxylation product of the formula (I), which preferably has an average of between 2.0 and 8.0 ethoxysilyl functions per alkoxylation product of the formula (I), from 0.3 wt % to 5.0 wt %, preferably from 0.5 wt % to 4.0 wt % and more preferably from 1.0 wt % to 2.5 wt % based on the overall composition of adhesion promoter, less than 30 wt % based on the overall composition of plasticizer, with the mass ratio of alkoxylation product of the formula (I) to plasticizer being more preferably less than 1.1 times that of the alkoxylation product of the formula (I), from 1 to 70 wt % based on the overall composition of fillers, from 0.2 to 3.0 wt % based on the overall composition of chemical moisture-drying agents, and from 0.1 wt % to 5.00 wt %, preferably 0.2 to 3.00 wt % and more particularly 0.1 to 5 wt % based on the overall composition of curing catalysts. In the case of especially preferred compositions, the stated fractions of the formulation ingredients are selected such that the sum total of the fractions adds up to 100 wt %.

The compositions of the invention may be, for example, adhesives or sealants, or may be used for producing an adhesive or sealant.

The composition of the invention, more particularly the composition of the invention thus obtained, cures within time periods comparable with existing commercially available and industrially employed products, and also undergoes very good depthwise crosslinking if applied in relatively thick films. The flank adhesion and attachment to different substrates, such as steel, aluminium, various plastics and mineral substrates, such as stone, concrete and mortar, for example, are particularly good.

The compositions of the invention may be used in particular for reinforcing, levelling, modifying, adhesively bonding, sealing and/or coating of substrates. Suitable substrates are, for example, particulate or sheetlike substrates, in the construction industry or in vehicle construction, structural elements, components, metals, especially construction materials such as iron, steel, including stainless steel, and cast iron, ceramic materials, especially based on solid metal oxides or non-metal oxides or carbides, aluminium oxide, magnesium oxide or calcium oxide, mineral or organic substrates, especially cork and/or wood, mineral substrates, chipboard and fiberboard made from wood or cork, composite materials such as, for example, wood composite materials such as MDF boards (medium-density fiberboard), WPC articles (wood plastic composites), chipboard, cork articles, laminated articles, ceramics, and also natural fibers and synthetic fibers (and substrates comprising them), or mixtures of different substrates. With particular preference the compositions of the invention are used in the sealing and/or coating of particulate or sheetlike substrates, in the construction industry or in vehicle construction, for the sealing and adhesive bonding of structural elements and components, and also for the coating of porous or non-porous, particulate or sheetlike substrates, for the coating or modification of surfaces and for applications on metals, particularly on construction materials such as iron, steel, including stainless steel, and cast iron, for application on ceramic materials, especially based on solid metal oxides or non-metal oxides or carbides, aluminium oxide, magnesium oxide or calcium oxide, on mineral substrates or organic substrates, especially on cork and/or wood, for the binding, reinforcement and levelling of uneven, porous or fractious substrates, such as for example, mineral substrates, for example, chipboard and fiberboard made from wood or cork, composite materials such as, wood composites such as MDF boards (medium-density fiberboard), WPC articles (wood plastic composites), chipboard, cork articles, laminated articles, ceramics, but also natural fibers and synthetic fibers, or mixtures of different substrates.

As a result of this broad spectrum of adhesion, they are also suitable for the bonding of combinations of materials comprising the substrates stated. In this context it is not critical whether the surfaces are smooth or roughened or porous. Roughened or porous surfaces are preferred, on account of the greater area of contact with the adhesive.

The compositions of the invention are applied preferably in a temperature range of 10° C.-40° C. and also cure effectively under these conditions. In view of the moisture-dependent curing mechanism, a relative atmospheric humidity of min. 35% to max. 75% is particularly preferred for effective curing. The cured adhesive bond (composition) can be used within a temperature range of −10° C. to 80° C. The adhesive bonds produced with the compositions of the invention are resistant to water at T<60° C. and to non-swelling solvents. The adhesive bond is not resistant to solvents which swell the formulation, such as methanol, ethanol, toluene, tetrahydrofuran, acetone or isopropanol, for example.

Swellability by ethanol, which is formed during the crosslinking reaction of the alkoxylation products, is a fundamental prerequisite, since the ethanol formed does not hinder curing even within large, extensive bonds. It is transported away to the edges, where it evaporates. Accordingly, rapid curing of the extensive bond is ensured with the formulations of the invention.

Formulations based on the alkoxylation products of the invention are suitable preferably for the adhesive bonding and/or sealing of particulate or sheetlike substrates. A further possibility for service is use of the formulations in the construction industry or in vehicle building, for the sealing and bonding of structural elements and components, and also for the coating of porous or non-porous, particulate or sheetlike substrates. Further examples which may be given here are applications on metals, in that case in particular the construction materials such as iron, steel, stainless steel and cast iron, ferrous materials, aluminium, mineral substrates, such as stone, screeding, mortar and concrete, ceramics, glasses, ceramic materials, based in particular on solid metal oxides or non-metal oxides or carbides, aluminium oxide, magnesium oxide or calcium oxide, and also mineral substrates or organic substrates, polyesters, glass fiber-reinforced polyester, polyamide, textiles and fabrics made from cotton and polyester, cork and/or wood. The composition may likewise be utilized for binding, reinforcing and levelling uneven, porous or friable substrates, such as, for example, mineral substrates, chipboard and fiberboard panels made of wood or cork, composite materials such as, for example, wood composites such as MDF boards (medium-density fiberboards), WPC articles (wood plastic composites), chipboard panels, cork articles, laminated articles, ceramics, but also natural fibers and synthetic fibers. As a result of this broad spectrum of adhesion, they are also suitable for the bonding of combinations of materials comprising the substrates stated. In this context it is not critical whether the surfaces are smooth or roughened or porous. Roughened or porous surfaces are preferred, on account of the greater area of contact with the adhesive.

The alkoxylation products that are used in this invention may additionally be used for the coating and modifying of surfaces and fibers.

The alkoxylation products may therefore serve, for example, as base materials for the preparation of adhesives, as reactive crosslinkers, as adhesion promoters and primers and also binders for metals, glass and glass fibers/glass fabrics, wood, wood-based materials, natural fibers, for the finishing and treatment of textile and non-textile fabrics and fibers made from natural and/or synthetic and also mineral raw materials, and also, for example, cork, leather, paper, tissue and silicatic and oxidic materials. The present invention therefore further provides for the use of the above-described alkoxylation products for production of adhesives, as reactive crosslinkers, as adhesion promoters, as primers or as binders.

The present invention further provides for the use of acetoacetate esters and diketene for reduction of the viscosity of alkoxylation products which bear alkoxysilyl groups. Preference is given to the use of acetoacetate esters and diketene for reducing the viscosity of alkoxylation products which bear alkoxysilyl groups by modification of the free OH groups at the chain end of the alkoxylation product with acetoacetate esters and diketene.

The examples adduced below illustrate the present invention by way of example, without any intention of restricting the invention, the scope of application of which is apparent from the entirety of the description and the claims, to the embodiments specified in the examples.

### EXAMPLES

### General Remarks:

The viscosity was determined shear rate-dependently at 25° C. with the MCR301 rheometer from Anton Paar in a plate/plate arrangement with a gap width of 1 mm. The diameter of the upper plate was 40 mm. The viscosity at a shear rate of 10 s⁻¹ was read off and is set out in Table 1.

### Examples for Process Step (1)—Alkoxylation Reaction

### Example 1 (Inventive)

### Synthesis of a PPG-Based Alkoxysilyl-Functional Polyether:

A 5 litre autoclave was charged with 500 g of PPG 2000, and 150 ppm (based on the total batch) of a zinc hexacyanocobaltate double metal cyanide catalyst were added. The reactor was inertized by charging with nitrogen to a pressure of 3 bar and subsequent decompression to atmospheric pressure. This operation was repeated twice more. While stirring, the contents of the reactor were heated to 130° C. and evacuated to about 20 mbar to remove volatile components. After 30 minutes, the catalyst was activated by the metered introduction into the evacuated reactor of 60 g of propylene oxide. The internal pressure initially rose to about 0.9 bar. After about 9 minutes, the reaction set in, this being noticeable through a drop in the reactor pressure. 1250 g of propylene oxide were then metered in continuously over about 55 minutes. This was followed by one hour of further reaction, during which the temperature was lowered to 95° C. At this temperature, a mixture of 209 g of Dynasylan® GLYEO (from Evonik) and 1042 g of propylene oxide was metered in continuously at a rate such that the temperature remained constant. After another one hour of further reaction, the batch was deodorized by application of a pressure (P<100 mbar), in order to remove residues of unreacted alkylene oxide. Then 500 ppm of Irganox® 1135 (from BASF) were stirred in for 15 minutes. A colorless product of high viscosity was obtained, having a mean molecular weight of 12 000 g/mol, according to the starting weights.

### Example 2 (Inventive)

### Synthesis of a PPG-Based Alkoxysilyl-Functional Polyether:

A 5 litre autoclave was charged with 333 g of PPG 2000, and 150 ppm (based on the total batch) of a zinc hexacyanocobaltate double metal cyanide catalyst were added. The reactor was inertized by charging with nitrogen to a pressure of 3 bar and subsequent decompression to atmospheric pressure. This operation was repeated twice more. While stirring, the contents of the reactor were heated to 130° C. and evacuated to about 20 mbar to remove volatile components. After 30 minutes, the catalyst was activated by the metered introduction into the evacuated reactor of 50 g of propylene oxide. The internal pressure initially rose to about 0.9 bar. After about 15 minutes, the reaction set in, this being noticeable through a drop in the reactor pressure. 117 g of propylene oxide were then metered in continuously over about 5 minutes. This was followed by one hour of further reaction. Then a mixture of 541 g of ethylene oxide and 788 g of propylene oxide was added on and, after further reaction for thirty minutes, a further 167 g of propylene oxide within about 10 minutes. This was then followed by about 90 minutes of further reaction, during which the temperature was lowered to 95° C. At this temperature, finally, a mixture of 162 g of Dynasylan® GLYEO (from Evonik) and 844 g of propylene oxide was metered in continuously at a rate such that the temperature remained constant. After another one hour of further reaction, the batch was deodorized by application of a pressure (P<100 mbar), in order to remove residues of unreacted alkylene oxide. Then 500 ppm of Irganox® 1135 (from BASF) were stirred in for 15 minutes. A colorless product of high viscosity was obtained, having a mean molecular weight of 18 000 g/mol, according to the starting weights.

### Examples for Process Step (2)—End-Capping Reaction

### Example 3 (Comparative Example)

End-Capping of the Polyether from Example 1 with Isophorone Diisocyanate (Process According to EP 2636696):

A 1 l three-neck flask with precision glass stirrer was initially charged under nitrogen with 750.8 g of silyl polyether from Example 1 and heated to 70° C. Then 33.4 g of IPDI were added, the mixture was stirred for five minutes, and 0.05 ml of TIB Kat 216 (dioctyltin dilaurate) were added. The mixture was stirred for 45 minutes and 67.8 g of polyether of the general formula C₄H₉O[CH₂CH(CH₃)O]_{5.6}H were added. The mixture was subsequently stirred at 70° C. for a further 5 hours.

### Example 4 (Inventive)

End-Capping of the Polyether from Example 1 with Tert-Butyl Acetoacetate

A 1 l three-neck flask equipped with a reflux condenser and a precision glass stirrer was initially charged under nitrogen with 721.8 g of silyl polyether from Example 1 and heated to 100° C. At this temperature, 19.1 g of tert-butyl acetoacetate were added dropwise over a period of 10 minutes. Three hours of further reaction were followed, finally, by distillation under reduced pressure at about 15 mbar for one hour, in order to remove reaction by-products and low molecular weight impurities.

### Example 5 (Inventive)

End-Capping of the Polyether from Example 1 with Tert-Butyl Acetoacetate

A 1 l three-neck flask equipped with a reflux condenser and a precision glass stirrer was initially charged under nitrogen with 720.6 g of silyl polyether from Example 1 and heated to 100° C. At this temperature, 19.1 g of tert-butyl acetoacetate were added dropwise over a period of 10 minutes. After three hours of further reaction, the reaction was ended without distillation.

### Example 6 (Inventive)

End-Capping of the Polyether from Example 1 with Ethyl Acetoacetate

A 1 l three-neck flask equipped with a reflux condenser and a precision glass stirrer was initially charged under nitrogen with 714.3 g of silyl polyether from Example 1 and heated to 110° C. At this temperature, 15.5 g of ethyl acetoacetate were added dropwise over a period of 15 minutes. Three hours of further reaction were followed, finally, by distillation under reduced pressure at about 15 mbar for one hour, in order to remove reaction by-products and low molecular weight impurities.

### Example 7 (Inventive)

A 500 ml three-neck flask equipped with a reflux condenser and a precision glass stirrer was initially charged under nitrogen with 160 g of silyl polyether from Example 1. At room temperature, 4.64 g of tert-butyl acetoacetate were added and the reaction mixture was heated to 100° C. Three hours of further reaction were followed by distillation under reduced pressure at about 15 mbar for 30 minutes. Then the flask was vented with nitrogen to standard pressure and, subsequently, a further 2.32 g of tert-butyl acetoacetate were added. After a further three hours of further reaction time, finally, a further distillation was conducted under reduced pressure at about 15 mbar for 30 minutes, in order to remove reaction by-products and low molecular weight impurities.

### Example 8 (Inventive)

A 500 ml three-neck flask equipped with a reflux condenser and a precision glass stirrer was initially charged under nitrogen with 250 g of silyl polyether from Example 1 and 6.6 g of tert-butyl acetoacetate were added. The reaction mixture was heated to 120° C. and stirred at this temperature for three hours. Finally, a distillation was conducted under reduced pressure at about 15 mbar for one hour, in order to remove reaction by-products and low molecular weight impurities.

### Example 9 (Inventive)

A 500 ml three-neck flask equipped with a reflux condenser and a precision glass stirrer was initially charged under nitrogen with 123.2 g of silyl polyether from Example 1 and 4.86 g of tert-butyl acetoacetate were added. The reaction mixture was heated to 100° C. and stirred at this temperature for three hours. Finally, a distillation was conducted under reduced pressure at about 15 mbar for one hour, in order to remove reaction by-products and low molecular weight impurities.

### Example 10 (Comparative Example)

A 500 ml three-neck flask equipped with a reflux condenser and a precision glass stirrer was initially charged under nitrogen with 123.2 g of silyl polyether from Example 1 and 0.15 g of titanium(IV) isopropoxide (as catalyst), and 4.86 g of tert-butyl acetoacetate were added. The reaction mixture was heated to 100° C. and stirred at this temperature for three hours. Finally, a distillation was conducted under reduced pressure at about 15 mbar for one hour, in order to remove reaction by-products and low molecular weight impurities.

### Example 11 (Inventive)

Example 11 was conducted analogously to Example 4. 1231 g of silyl polyether from Example 2 and 21.6 g of tert-butyl acetoacetate were used.

### Example 12 (Inventive)

Example 12 was conducted analogously to Example 6. 1231 g of silyl polyether from Example 2 and 17.8 g of ethyl acetoacetate were used.

### Performance Study

### Determination of Storage Stability

To evaluate the storage stability, all the alkoxylation products from Examples 1-12 were formulated by the procedure described in Example 13.

### Example 13 (Inventive)

19.9 g in each case of the alkoxylation products from Examples 1-12 were introduced into a previously argon-flooded screwtop bottle, 0.1 g of TIB Kat 223 was added and the mixture was mixed thoroughly with the aid of a spatula. The mixture was blanketed once again with argon and closed with a screwtop. The samples were then stored at 60° C. in a heating cabinet for 4 weeks and the flowability of the mixture was checked at regular intervals. The results are summarized in Table 1.

TABLE 1
Viscosities and storage stabilities of the
uncapped (Examples 1 + 2) and end-
capped (Examples 3-12) alkoxylation products

| | Viscosity: | Storage test |
|---|---|---|
| Example | (25° C.) [Pa · s] | (consistency after 4 wks.) |
| 1 | 8.0 | solid |
| 2 | 16.3 | solid |
| 3 | 30.7 | liquid |
| 4 | 8.1 | liquid |
| 5 | 6.8 | liquid |
| 6 | 7.2 | liquid |
| 7 | 7.9 | liquid |
| 8 | 8.3 | liquid |
| 9 | 7.9 | liquid |
| 10 | 11.7 | solid |
| 11 | 15.5 | liquid |
| 12 | 15.8 | liquid |

### Preparation of the Room-Temperature-Applicable Adhesive/Sealant Formulations:

25.9 wt % of the alkoxylation product from the respective examples was mixed vigorously with 18.1 wt % of diisoundecyl phthalate, 51.1 wt % of precipitated chalk (Socal® U1S2, Solvay), 0.5 wt % of titanium dioxide (Kronos® 2360, Kronos), 1.4 wt % of adhesion promoter (Dynasylan® 1189, Evonik), 1.1 wt % of drying agent (Dynasylan® VTMO, Evonik), 1.5 wt % of an antioxidant/stabilizer mixture (ratio of Irganox® 1135 to Tinuvin® 1130 to Tinuvin® 292=1:2:2 ratio) and 0.4 wt % of the curing catalyst (TM® KAT 223, TIB) in a mixer (Speedmixer® FVS 600, Hausschild). The completed formulation was transferred to PE cartridges, and was stored for at least 24 hours at room temperature prior to application. Given that the formulations of the alkoxylation products in the examples stated above were identical in all cases, the discussion of the results has been carried out with identification of the alkoxylation product utilized as the basis of the formulation.

Determination of Breaking Force and Elongation at Break in Accordance with DIN 53504:

The formulation was knifecoated in a film thickness of 2 mm onto a PE surface. The films were stored for 7 days at 23° C. and 50% relative humidity. S2 dumbbell specimens were then punched from the films with the aid of a cutter and a toggle press.

The dumbbell specimens thus produced were clamped for testing into a universal testing machine (from Shimadzu), and determinations were made of the breaking stress and elongation at break when the specimens were stretched at a constant velocity (200 mm/min).

Determination of the Tensile Shear Strength of Overlap Bonds in Accordance with DIN EN 1465

Overlap bonds were produced with the prepared formulation. For these bonds, two stainless steel substrates (V2A, 1.4301) were used. The region of the overlap bond amounted to 500 mm². The bonds were cured at 23° C. and 50% relative humidity. After 21 days, the bonds were clamped into a universal testing machine (from Shimadzu), and a force was exerted on the adhesive bond at a constant rate (10 mm/min) until the bond fractured. The breaking force was ascertained.

TABLE 2
Mechanical characteristic values of the cured formulation on an
S2 dumbbell and on an overlap bond of two V2A steel plates:

| | S2 dumbbell specimen | | | |
|---|---|---|---|---|
| | Elongation at | | Adhesive bond | Depth |
| Polymer of | break | Breaking stress | Breaking stress | curing |
| example | [%] | [N/mm²] | [N/mm²] | [mm]/24 h |
| 1 | 246 | 0.53 | 0.41 | 1.8 |
| 3 | 409 | 0.83 | 0.79 | 1.9 |
| 4 | 301 | 0.64 | 0.64 | 1.9 |
| 5 | 316 | 0.63 | 0.64 | 1.8 |
| 6 | 310 | 0.54 | 0.68 | 2.0 |

### CONCLUSION

As can be inferred from Table 1, the uncapped alkoxylation products of Examples 1 and 2 and the polyethers from Example 9 which have been end-capped by means of titanate catalysis are not storage-stable. All the other alkoxylation products were storage-stable according to Example 13, as were Inventive Examples 4-8 and 10-12 and Comparative Example 3. On closer inspection of the viscosities, it is found that the end-capping of the alkoxylation products by the processes of the invention (Examples 4-8 and 10-12) has virtually no effect on the viscosity of the alkoxylation products and hence they have much lower and better processible viscosities than Comparative Example 3 capped with isophorone diisocyanate.

It can be inferred from the performance properties according to Table 2 that no significant differences are found with the products of the invention from Examples 4-6 as compared with the isophorone-capped alkoxylation product (Example 3). Compared to the uncapped product (Example 1), higher elongation values and higher strengths are observed with the inventive products (Examples 4-6).

1. An alkoxylation product comprising at least one non-terminal alkoxysilyl group, formed from monomers of at least one alkylene oxide and at least one epoxide bearing alkoxysilyl groups, wherein at least 30% of all the free OH groups on the chain end of the alkoxylation product have been converted to acetoacetate groups.

2. The alkoxylation product according to claim 1, wherein at least 30% of all the free OH groups on the chain end of the alkoxylation product have been converted to acetoacetate groups.

3. The alkoxylation product according to claim 1, wherein the alkoxylation product has a viscosity of ≦25 Pa·s.

4. The alkoxylation product according claim 1, wherein the alkoxylation products correspond to the formula (I) 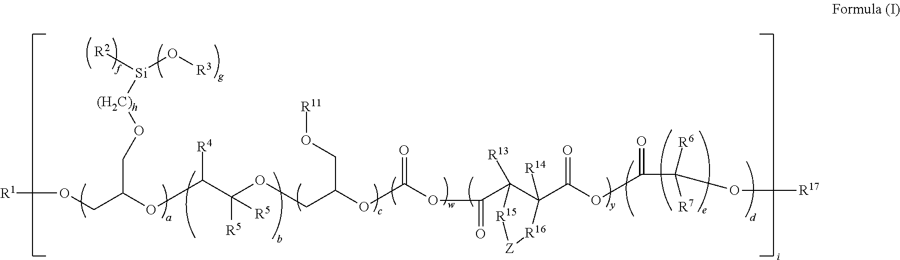
where
a=0 to 100,
b=0 to 1000,
c=0 to 200,
d=0 to 200,
w=0 to 200,
y=0 to 500,
e=1 to 10,
f=0 to 2,
g=1 to 3
with the proviso that g+f=3
h=0 to 10,
i=1 to 10,
with the proviso that the groups with the indices a, b, c, d, w and y are freely permutable over the molecule chain, it being disallowed for each of the groups with the indices w and y to follow itself or the other respective group, and
with the proviso that the various monomer units both of the fragments having the indices a, b, c, d, w and y and of any polyoxyalkylene chain present in the substituent R¹ may be constructed blockwise among one another, it also being possible for individual blocks to occur multiply and to be distributed statistically among one another, or else are subject to a statistical distribution and, moreover, are freely permutable with one another, in the sense of being for arrangement in any desired order, with the restriction that each of the groups of the indices w and y must not follow itself or the other respective group,
and where
R¹=independently at each occurrence R¹⁷ or a saturated or unsaturated, linear or branched organic hydrocarbon radical which may contain O, S and/or N as heteroatoms,
the hydrocarbon radical comprises 1 to 400 carbon atoms,
R²=independently at each occurrence an alkyl group having 1 to 8 carbon atoms,
R³=independently at each occurrence an alkyl group having 1 to 8 carbon atoms,
R⁴=independently at each occurrence a hydrogen radical, an alkyl group having 1 to 20 carbon atoms, or an aryl or alkaryl group,
R⁵=independently at each occurrence a hydrogen radical or an alkyl group having 1 to 8 carbon atoms,
or R⁴ and one of the radicals R⁵ may together form a ring which includes the atoms to which R⁴ and R⁵ are bonded,
R⁶ and R⁷=independently at each occurrence a hydrogen radical, an alkyl group having 1 to 20 carbon atoms, or an aryl or alkaryl group or an alkoxy group,
R¹¹=independently at each occurrence a saturated or unsaturated, aliphatic or aromatic, hydrocarbon radical having 2 to 30 carbon atoms, which is optionally substituted,
R¹³, R¹⁴=independently at each occurrence hydrogen or an organic radical,
the bridging Z fragment may be present or absent,
when the bridging Z fragment is absent, then
R¹⁵ and R¹⁶=independently at each occurrence hydrogen or an organic radical, where, if one of the R¹³ and R¹⁴ radicals is absent, the respective geminal radical is an alkylidene radical,
when the bridging Z fragment is present, then
R¹⁵ and R¹⁶=hydrocarbon radicals which are bridged cycloaliphatically or aromatically via the Z fragment, Z representing a divalent alkylene or alkenylene radical which may be further substituted,
R¹⁷=independently at each occurrence hydrogen or a radical of the formula (II) 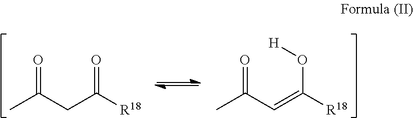
where
R¹⁸=independently at each occurrence a linear or branched, saturated or unsaturated, optionally further-substituted alkyl group having 1 to 30 carbon atoms, or an aryl or alkaryl group,
and with the proviso that at least 30% of the R¹⁷ radicals correspond to formula (II).

5. The alkoxylation product according to claim 4, where
a=1 to 50,
b=1 to 500,
c=0 to 50,
d=0 to 50,
w=0 to 50,
y=0 to 100,
e=1 to 10,
f=0 to 2,
g=1 to 3
with the proviso that g+f=3
h=1 to 6 and
i=1 to 5.

6. The alkoxylation product according to claim 4 with
a=1 to 20,
b=10 to 500,
c=0 to 20,
d=0 to 20,
w=0 to 20,
y=0 to 20,
e=1 to 10,
f=0 to 2,
g=1 to 3
with the proviso that g+f=3
h=1, 2 or 3
i=1, 2 or 3 and
R¹=independently at each occurrence R¹⁷ or an alkyl radical having 2 to 12 carbon atoms,
R²=independently at each occurrence a methyl, ethyl, propyl or isopropyl group,
R³=independently at each occurrence a methyl, ethyl, propyl or isopropyl group,
R⁴=independently at each occurrence hydrogen or a methyl, ethyl, octyl, decyl, dodecyl, phenyl or benzyl group,
R⁵=independently at each occurrence hydrogen or a methyl or ethyl group,
R¹¹=independently at each occurrence an optionally substituted alkyl chain having 4 to 20 carbon atoms,
R¹⁷=independently at each occurrence hydrogen or a radical of the formula (II) 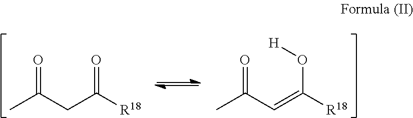
where
R¹⁸=methyl, ethyl or phenyl,
and with the proviso that at least 30% of the R¹⁷ radicals correspond to formula (II).

7. An alkoxylation product containing at least one non-terminal alkoxysilyl group and wherein at least 30% of all the free OH groups on the chain end of the alkoxylation product have been converted to acetoacetate groups, obtainable by reaction of at least one alkylene oxide with at least one epoxide bearing alkoxysilyl groups and optionally further monomers and subsequent reaction of the product obtained with acetoacetate esters and/or diketene.

8. The alkoxylation product according to claim 7, wherein at least ethylene oxide and/or propylene oxide is used as alkylene oxide and at least one n-glycidyloxyalkyltrialkoxysilane as epoxide bearing alkoxysilyl groups.

9. A process for preparing alkoxylation products according to claim 1, wherein at least one alkylene oxide is reacted with at least one epoxide bearing alkoxysilyl groups and further monomers, and the product thus obtained is reacted with acetoacetate esters and/or diketene.

10. The process according to claim 9, comprising the steps of
(1) reacting at least one starter selected from the group of the alcohols, polyetherols and phenols with at least one alkylene oxide and at least one epoxide bearing alkoxysilyl groups, and
(2) reacting the OH-terminated alkoxylation product from step (1) with at least one acetoacetate ester or diketene,
wherein starters are OH-functional compounds and the alkylene oxides and reactants are those defined above as preferred.

11. The process according to claim 9, wherein the starter R¹—(OH)ᵢ is selected from methanol, ethanol, propanol, isopropanol, butanol, isobutanol, tert-butanol, 2,2,4-trimethylpentane-1,3-diol monoisobutyrate, octanol, 2-ethylhexanol, 2-propylheptanol, allyl alcohol, decanol, dodecanol, C₁₂/C₁₄ fatty alcohol, phenol, all constitutional isomers of cresol, benzyl alcohol, stearyl alcohol, ethylene glycol, propylene glycol, di-/triethylene glycol, 1,2-propylene glycol, di-/tripropylene glycol, neopentyl glycol, butane-1,4-diol, hexane-1,2-diol and hexane-1,6-diol, trimethylolpropane monoethers or glycerol monoethers, polyethylene oxides, polypropylene oxides, polyesters, polycarbonates, polycarbonate polyols, polyester polyols, polyether esters, polyetherols, polyether carbonates, polyamides, polyurethanes and sugar-based alkoxylates and mixtures thereof.

12. The process according to claim 9, wherein the alkylene oxide is selected from ethylene oxide, 1,2-epoxypropane, 1,2-epoxy-2-methylpropane, epichlorohydrin, 2,3-epoxy-1-propanol, 1,2-epoxybutane, 2,3-epoxybutane, 2,3-dimethyl-2,3-epoxybutane, 1,2-epoxypentane, 1,2-epoxy-3-methylpentane, 1,2-epoxyhexane, 1,2-epoxycyclohexane, 1,2-epoxyheptane, 1,2-epoxyoctane, 1,2-epoxynonane, 1,2-epoxydecane, 1,2-epoxyundecane, 1,2-epoxydodecane, styrene oxide, 1,2-epoxycyclopentane, 1,2-epoxycyclohexane, vinylcyclohexene oxide, (2,3-epoxypropyl)benzene, vinyloxirane, 3-phenoxy-1,2-epoxypropane, 2,3-epoxy methyl ether, 2,3-epoxy ethyl ether, 2,3-epoxy isopropyl ether, 3,4-epoxybutyl stearate, 4,5-epoxypentyl acetate, 2,3-epoxypropane methacrylate, 2,3-epoxypropane acrylate, glycidyl butyrate, methyl glycidate, ethyl 2,3-epoxybutanoate, 4-(trimethylsilyl)butane 1,2-epoxide, 4-(triethylsilyl)butane 1,2-epoxide, 3-(perfluoromethyl)-1,2-epoxypropane, 3-(perfluoroethyl)-1,2-epoxypropane, 3-(perfluorobutyl)-1,2-epoxypropane, 3-(perfluorohexyl)-1,2-epoxypropane, 4-(2,3-epoxypropyl)morpholine, 1-(oxiran-2-ylmethyl)pyrrolidin-2-one and mixtures thereof, and where the epoxide bearing alkoxysilyl groups is selected from 3-glycidyloxypropyltrimethoxysilane, 3-glycidyloxypropyltriethoxysilane, 3-glycidyloxypropyltripropoxysilane, 3-glycidyloxypropyltriisopropoxysilane, bis(3-glycidyloxypropyl)dimethoxysilane, bis(3-glycidyloxypropyl)diethoxysilane, 3-glycidyloxyhexyltrimethoxysilane, 3-glycidyloxyhexyltriethoxysilane, 3-glycidyloxypropylmethyldimethoxysilane, 3-glycidyloxypropylethyldiethoxysilane and mixtures thereof.

13. The process according to claim 9, wherein the acetoacetate esters and diketenes are selected from diketene, methyl acetoacetate, ethyl acetoacetate, allyl acetoacetate, propyl acetoacetate, isopropyl acetoacetate, butyl acetoacetate, isobutyl acetoacetate, tert-butyl acetoacetate, pentyl acetoacetate, hexyl acetoacetate, heptyl acetoacetate, 2-methoxyethyl acetoacetate, 2-(methacryloyloxy)ethyl acetoacetate, benzyl acetoacetate and mixtures thereof.

14. Adhesives and sealants, as reactive diluent in adhesive sealant formulations, for coating and modification of surfaces and fibers, as reactive crosslinker, as adhesion promoter, as primer or as binder, said adhesives and sealants comprising alkoxylation product according to claim 1.

15. The alkoxylation product according to claim 1, wherein at least 40% of all the free OH groups on the chain end of the alkoxylation product have been converted to acetoacetate groups.
The alkoxylation product according to claim 1, wherein at least 30% of all the free OH groups on the chain end of the alkoxylation product have been converted to acetoacetate groups

16. The alkoxylation product according to claim 2, wherein the alkoxylation product has a viscosity of ≦25 Pa·s.

17. The alkoxylation product according to claim 1, wherein the alkoxylation product has a viscosity of ≦15 Pa·s.

18. The alkoxylation product according to claim 4, wherein
a=1 to 100
R¹=independently at each occurrence R¹⁷ or a saturated or unsaturated, linear or branched organic hydrocarbon radical which may contain O, S and/or N as heteroatoms,
the hydrocarbon radical comprises 2 to 200 carbon atoms,
wherein R⁴ and one of the radicals R⁵ may together form a ring comprising 5 to 8 carbon atoms,
R¹³, R¹⁴=alkyl, alkenyl, alkylidene, alkoxy, aryl or aralkyl groups, or else optionally R¹³ and/or R¹⁴ may be absent, where, when R¹³ and R¹⁴ are absent, there is a C═C double bond in place of the R¹³ and R¹⁴ radicals,
R¹⁷=independently at each occurrence hydrogen or a radical of the formula (II) 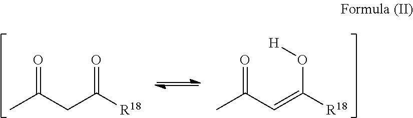
where
R¹⁸=methyl, ethyl, phenyl, more preferably methyl or ethyl.

19. The alkoxylation product according to claim 1, wherein at least 60% of all the free OH groups on the chain end of the alkoxylation product have been converted to acetoacetate groups.

20. The alkoxylation product according to 2, wherein the alkoxylation product has a viscosity of ≦10 Pa·s.
